(19) United States
(12) Patent Application Publication
(10) Pub. No.: US 2026/0098107 A1
(43) Pub. Date: Apr. 9, 2026

(54) METHODS OF MAKING LOW GEL PEROXIDE-MODIFIED LINEAR LOW DENSITY POLYETHYLENE

(71) Applicant: Chevron Phillips Chemical Company LP, The Woodlands, TX (US)

(72) Inventors: Jeffrey S. Lowell, Kingwood, TX (US); Eungkyu Kim, Bartlesville, OK (US); Jinping Zhou, Bartlesville, OK (US); Shawn P. Ward, Bartlesville, OK (US); Cory D. Pullins, Bartlesville, OK (US); Joseph A. Tabuena, Baytown, TX (US); Mark W. Bechtel, Baytown, TX (US)

(21) Appl. No.: 19/346,695

(22) Filed: Oct. 1, 2025

Related U.S. Application Data
(60) Provisional application No. 63/702,694, filed on Oct. 3, 2024.

(51) Int. Cl. C08F 8/06; B29C 48/00; B29C 48/04; B29C 48/05; B29C 48/08; B29K 23/00; C08J 3/22; C08J 5/18; C08L 23/30

(52) U.S. Cl. CPC C08F 8/06; B29C 48/0018; B29C 48/022; B29C 48/04; B29C 48/05; B29C 48/08; C08J 3/22; C08J 5/18; C08L 23/30; B29K 2023/08; B29K 2995/0081; B29K 2995/0089; C08L 2310/00

(57) ABSTRACT

Ethylene-based polymers having a melt index of 0.1-0.7 g/10 min, a high load melt index of 5-20 g/10 min, and a density of 0.91-0.93 g/cm³ are disclosed. These polymers contain 3-50 ppmw of calcium and/or have a gel count of less than or equal to 100 gels/ft², in which the gels have a size in diameter of 200-800 microns in a 50 micron thick film. Further, these polymers can be characterized by one of more of a tan δ at 0.1 sec⁻¹ of 1.5-4.5, a CY-a parameter of 0.15-0.35, and/or from 2.5-13 long chain branches per 1,000,000 total carbon atoms. The ethylene polymers are produced by a method that includes blending a first portion of a base polymer and a peroxide compound to produce a first mixture and contacting the first mixture with a second portion of the base polymer and an additive. The amount of the peroxide compound is 2-50 ppmw of peroxide groups based on the weight of the ethylene polymer.

### REFERENCE TO RELATED APPLICATION

This application claims the benefit of U.S. Provisional Patent Application No. 63/702,694, filed on Oct. 3, 2024, the disclosure of which is incorporated herein by reference in its entirety.

### TECHNICAL FIELD

The present disclosure generally relates to methods for making peroxide-modified resins and films that have a low gel content, and more particularly, to LLDPE resins having excellent melt strength, tear resistance, impact strength, and tensile properties, which can be utilized in a variety of film and related end-use applications.

### BACKGROUND

Peroxide treatment of polyolefins, such as linear low density polyethylene (LLDPE) copolymer, can enhance melt strength, tensile strength, and impact strength. However, the peroxide crosslinking reaction can result in a significant increase in gels. High levels of gels prevent the peroxide-modified polymer from being utilized in many applications, such as gel sensitive film applications. Thus, there is a need for improved peroxide-modified polymers that exhibit a low number of gels without sacrificing other desirable polymer and film attributes. Accordingly, it is to these ends that the present invention is generally directed.

### SUMMARY

This summary is provided to introduce a selection of concepts in a simplified form that are further described herein. This summary is not intended to identify required or essential features of the claimed subject matter. Nor is this summary intended to be used to limit the scope of the claimed subject matter.

Aspects of this invention are directed to low density ethylene-based polymers (e.g., LLDPE). For instance, the ethylene polymers can have (or can be characterized by) a melt index (MI) in a range from 0.1 to 0.7 g/10 min, a high load melt index (HLMI) in a range from 5 to 20 g/10 min, and a density in a range from 0.91 to 0.93 g/cm³. The ethylene polymers can have (1) from 3 to 50 ppm by weight of calcium, or (2) a gel count of less than or equal to 100 gels/ft², wherein gels have a size in diameter of 200-800 microns in a 50 micron thick film, or both (1) and (2). The ethylene polymers also can have at least one of (A) a tan δ at 0.1 sec⁻¹ in a range from 1.5 to 4.5, and/or (B) a CY-a parameter in a range from 0.15 to 0.35, and/or (C) 2.5 to 13 long chain branches (LCBs) per 1,000,000 total carbon atoms. These ethylene polymers can be used to produce various articles of manufacture, such as blown or cast films having improved/reduced levels of gels.

Also encompassed herein are methods for making an ethylene polymer with less gels. A representative method can comprise (I) blending a first portion of a base polymer and a peroxide compound to produce a first mixture, (II) contacting the first mixture with a second portion of the base polymer and an additive to produce a second mixture, and (III) melt processing the second mixture through a die to produce the ethylene polymer. The amount of peroxide groups can range from 2 to 50 ppm, based on the weight of the ethylene polymer. Advantageously, and unexpectedly given the addition of peroxide, the ethylene polymer has an exceptionally low number of gels.

A related method provided herein is directed to a method for making a film with less gels. This method can comprise (i) blending a first portion of a base polymer and a peroxide compound to produce a first mixture, (ii) contacting the first mixture with a second portion of the base polymer and an additive to produce a second mixture, (iii) melt processing the second mixture through a die to produce an ethylene polymer, and (iv) melt processing the ethylene polymer through a film die to produce the film. The amount of peroxide groups can range from 2 to 50 ppm, based on the weight of the ethylene polymer. Beneficially, the film produced from the ethylene polymer has an exceptionally low number of gels.

Both the foregoing summary and the following detailed description provide examples and are explanatory only. Accordingly, the foregoing summary and the following detailed description should not be considered to be restrictive. Further, features or variations can be provided in addition to those set forth herein. For example, certain aspects can be directed to various feature combinations and sub-combinations described in the detailed description.

### BRIEF DESCRIPTION OF THE FIGURE

The following FIGURE forms part of the present specification and is included to further demonstrate certain aspects of the present invention. The invention may be better understood by reference to this FIGURE in combination with the detailed description.

FIG. 1 is a schematic flow diagram of a method for making an ethylene polymer with less gels and a method for making a film with less gels, consistent with aspects of the present disclosure.

While the inventions disclosed herein are susceptible to various modifications and alternative forms, only a few specific aspects have been shown by way of example in the drawing and described in detail below. The FIGURE and detailed description of specific aspects are not intended to limit the breadth or scope of the inventive concepts or the appended claims in any manner. Rather, the FIGURE and detailed description are provided to illustrate the inventive concepts to a person of ordinary skill in the art and to enable such person to make and use the inventive concepts.

### Definitions

To define more clearly the terms used herein, the following definitions are provided. Unless otherwise indicated, the following definitions are applicable to this disclosure. If a term is used in this disclosure but is not specifically defined herein, the definition from the IUPAC Compendium of Chemical Terminology, 2nd Ed (1997), can be applied, as long as that definition does not conflict with any other disclosure or definition applied herein, or render indefinite or non-enabled any claim to which that definition is applied. To the extent that any definition or usage provided by any document incorporated herein by reference conflicts with the definition or usage provided herein, the definition or usage provided herein controls.

Herein, features of the subject matter are described such that, within particular aspects, a combination of different features can be envisioned. For each and every aspect and/or feature disclosed herein, all combinations that do not detrimentally affect the polymer compositions and/or methods described herein are contemplated with or without explicit description of the particular combination. Additionally, unless explicitly recited otherwise, any aspect and/or feature disclosed herein can be combined to describe inventive features consistent with the present disclosure.

Generally, groups of elements are indicated using the numbering scheme indicated in the version of the periodic table of elements published in Chemical and Engineering News, 63(5), 27, 1985. In some instances, a group of elements can be indicated using a common name assigned to the group; for example, alkali metals for Group 1 elements, alkaline earth metals for Group 2 elements, transition metals for Group 3-12 elements, and halogens or halides for Group 17 elements.

For any particular compound disclosed herein, the general structure or name presented is also intended to encompass all structural isomers, conformational isomers, and stereoisomers that can arise from a particular set of substituents, unless indicated otherwise. Thus, a general reference to a compound includes all structural isomers unless explicitly indicated otherwise; e.g., a general reference to pentane includes n-pentane, 2-methyl-butane, and 2,2-dimethylpropane, while a general reference to a butyl group includes an n-butyl group, a sec-butyl group, an iso-butyl group, and a tert-butyl group. Additionally, the reference to a general structure or name encompasses all enantiomers, diastereomers, and other optical isomers whether in enantiomeric or racemic forms, as well as mixtures of stereoisomers, as the context permits or requires. For any particular formula or name that is presented, any general formula or name presented also encompasses all conformational isomers, regioisomers, and stereoisomers that can arise from a particular set of substituents.

The terms “a,” “an,” and “the” are intended to include plural alternatives, e.g., at least one, unless otherwise specified.

The terms “contacting” and “combining” are used herein to describe compositions and processes/methods in which the materials are contacted or combined together in any order, in any manner, and for any length of time, unless otherwise specified. For example, the materials can be blended, mixed, slurried, dissolved, reacted, treated, processed, impregnated, compounded, or otherwise contacted or combined in some other manner or by any suitable method or technique.

The term “hydrocarbon” refers to a compound containing only carbon and hydrogen. Other identifiers can be utilized to indicate the presence of particular groups in the hydrocarbon (e.g., halogenated hydrocarbon indicates the presence of one or more halogen atoms replacing an equivalent number of hydrogen atoms in the hydrocarbon). The term “hydrocarbyl group” is used herein in accordance with the definition specified by IUPAC: a univalent group formed by removing a hydrogen atom from a hydrocarbon (that is, a group containing only carbon and hydrogen). Non-limiting examples of hydrocarbyl groups include alkyl, alkenyl, aryl, and aralkyl groups, amongst other groups.

The term “polymer” is used herein generically to include olefin homopolymers, copolymers, terpolymers, and the like, as well as alloys and blends thereof. The term “polymer” also includes impact, block, graft, random, and alternating copolymers. A copolymer is derived from an olefin monomer and one olefin comonomer, while a terpolymer is derived from an olefin monomer and two olefin comonomers. Accordingly, “polymer” encompasses copolymers and terpolymers derived from any olefin monomer and comonomer(s) disclosed herein. Similarly, the scope of the term “polymerization” includes homopolymerization, copolymerization, and terpolymerization. Therefore, an ethylene polymer includes ethylene homopolymers, ethylene copolymers (e.g., ethylene/α-olefin copolymers), ethylene terpolymers, and the like, as well as blends or mixtures thereof. Thus, an ethylene polymer encompasses polymers often referred to in the art as LLDPE (linear low density polyethylene) and HDPE (high density polyethylene). As an example, an ethylene copolymer can be derived from ethylene and a comonomer, such as 1-butene, 1-hexene, or 1-octene. If the monomer and comonomer were ethylene and 1-hexene, respectively, the resulting polymer can be categorized an as ethylene/1-hexene copolymer. The term “polymer” also includes all possible geometrical configurations, unless stated otherwise, and such configurations can include isotactic, syndiotactic, and random symmetries. Moreover, unless stated otherwise, the term “polymer” also is meant to include all molecular weight polymers and is inclusive of lower molecular weight polymers.

The terms “catalyst composition,” “catalyst mixture,” “catalyst system,” and the like, do not depend upon the actual product or composition resulting from the contact or reaction of the initial components of the disclosed or claimed catalyst composition (or catalyst system), the nature of the active catalytic site, or the fate of the co-catalyst or the titanium and/or magnesium compound, after combining these components. Therefore, the terms “catalyst composition,” “catalyst mixture,” “catalyst system,” and the like, encompass the initial starting components of the composition, as well as whatever product(s) may result from contacting these initial starting components, and this is inclusive of both heterogeneous and homogenous catalyst systems or compositions. The terms “catalyst composition,” “catalyst mixture,” “catalyst system,” and the like, can be used interchangeably throughout this disclosure.

Several types of ranges are disclosed in the present invention. When a range of any type is disclosed or claimed, the intent is to disclose or claim individually each possible number that such a range could reasonably encompass, including end points of the range as well as any sub-ranges and combinations of sub-ranges encompassed therein. For example, the ethylene polymer can have various ratios of Mw/Mn in aspects of this invention. By a disclosure that the ratio of Mw/Mn is in a range from 2 to 6, the intent is to recite that the ratio of Mw/Mn can be any ratio in the range and, for example, can include any range or combination of ranges from 2 to 6, such as from 2 to 5, from 3 to 6, from 3 to 5, from 3.5 to 4.8, or from 4 to 4.8, and so forth. Likewise, all other ranges disclosed herein should be interpreted in a manner similar to this example.

In general, an amount, size, formulation, parameter, range, or other quantity or characteristic is “about” or “approximate” whether or not expressly stated to be such. Whether or not modified by the term “about” or “approximately,” the claims include equivalents to the quantities or characteristics.

Although any methods and materials similar or equivalent to those described herein can be used in the practice or testing of the invention, the typical methods and materials are herein described.

All publications and patents mentioned herein are incorporated herein by reference in their entirety for the purpose of describing and disclosing, for example, the constructs and methodologies that are described in the publications and patents, which might be used in connection with the presently described invention.

### DETAILED DESCRIPTION

The present disclosure is generally directed to LLDPE resins and films having a reduced number of gels, and to the methods for producing these LLDPE resins and films using peroxide treatment.

Peroxide treatment of polyolefins can impart desirable properties such as high melt strength, high tensile strength, and high impact strength. However, peroxide modification of LLDPE via a peroxide crosslinking reaction can result in a significant increase in gels. The high level of gels prevents the peroxide-modified polymer from being utilized in gel sensitive film applications because the gels can compromise the mechanical properties, appearance, and overall performance of the film.

An objective, therefore, of this invention is to produce peroxide-modified ethylene-based polymers and films that have a low number of gels. A further objective is to produce ethylene-based polymers and films that have a low number of gels in combination with the peroxide-modified ethylene-based polymer having excellent melt strength, tear resistance, impact strength, and tensile properties.

It was unexpectedly found that by blending (or pre-mixing) the peroxide compound with a small portion of the base polymer first, without the presence of an additive (or additives), the gel level of the final ethylene polymer is significantly reduced, compared to an ethylene polymer produced by mixing the base polymer, the peroxide compound, and the additive (or additives) together in one step, under the same processing conditions. While not wishing to be bound by theory, it is believed that the disclosed methods result in an improved dispersion of the peroxide compound into the base polymer. Thus, the efficiency of the peroxide crosslinking reaction is improved and the number of gels in the ethylene polymer is significantly reduced. Advantageously, due to the more efficient peroxide usage, less peroxide compound is needed to achieve the desired properties of the resultant ethylene polymer, such as high melt strength, high tensile strength, and high impact strength.

Further, peroxide treatment of polyolefins, which usually involves an additional heat history via a melt processing step such as extrusion, also can produce polymers (usually in the form of pellets) having an undesirable yellow off-color. Therefore, another objective of this invention is to produce ethylene polymers having excellent whiteness comparable to respective ethylene polymers that have not been subjected to peroxide treatment.

It is believed that peroxide-modified ethylene-based polymers having a melt index (MI) in a range from 0.1 to 0.7 g/10 min, a high load melt index (HLMI) in a range from 5 to 20 g/10 min, and a density in a range from 0.91 to 0.93 g/cm³, in combination with one or more of the following polymer attributes—a gel count of less than or equal to 100 gels/ft², wherein the gels have a size in diameter of 200-800 microns in a 50 micron thick film, a zero-shear viscosity in a range from 40 to 800 kPa-s, a relaxation time in a range from 0.08 to 0.8 sec, a CY-a parameter in a range from 0.10 to 0.37, a tan δ at 0.1 sec⁻¹ in a range from 1.5 to 4.8, and/or from 2 to 13 long chain branches (LCBs) per 1,000,000 total carbon atoms—meet these objectives and also provide additional benefits that are disclosed herein.

### Ethylene Polymers

Generally, the polymers disclosed herein are ethylene-based polymers, or ethylene polymers, encompassing homopolymers of ethylene as well as copolymers, terpolymers, etc., of ethylene and at least one olefin comonomer. Comonomers that can be copolymerized with ethylene often can have from 3 to 20 carbon atoms in their molecular chain. For example, typical comonomers can include, but are not limited to, propylene, 1-butene, 1-pentene, 1-hexene, 1-heptene, 1-octene, and the like, or combinations thereof. In an aspect, the olefin comonomer can comprise a C₃-C₁₈ olefin; alternatively, the olefin comonomer can comprise a C₃-C₁₀ olefin; alternatively, the olefin comonomer can comprise a C₄-C₁₀ olefin; alternatively, the olefin comonomer can comprise a C₃-C₁₀ α-olefin; alternatively, the olefin comonomer can comprise a C₄-C₁₀ α-olefin; alternatively, the olefin comonomer can comprise 1-butene, 1-hexene, 1-octene, or any combination thereof; or alternatively, the comonomer can comprise 1-hexene. Typically, the amount of the comonomer, based on the total weight of monomer (ethylene) and comonomer, can be in a range from 0.01 to 20 wt. %, from 0.01 to 1 wt. %, from 0.5 to 15 wt. %, from 0.5 to 2 wt. %, or from 1 to 15 wt. %.

In one aspect, the ethylene polymer of this invention can comprise an ethylene/α-olefin copolymer, while in another aspect, the ethylene polymer can comprise an ethylene homopolymer, and in yet another aspect, the ethylene polymer of this invention can comprise an ethylene/α-olefin copolymer and an ethylene homopolymer. For example, the ethylene polymer can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer.

An illustrative and non-limiting example of an ethylene polymer (e.g., comprising an ethylene copolymer) consistent with the present invention can have (or can be characterized by) a melt index (MI) in a range from 0.1 to 0.7 g/10 min, a high load melt index (HLMI) in a range from 5 to 20 g/10 min, and a density in a range from 0.91 to 0.93 g/cm³. Further, the ethylene polymer can have (1) from 3 to 50 ppm by weight of calcium, or (2) a gel count of less than or equal to 100 gels/ft², wherein the gels have a size in diameter of 200-800 microns in a 50 micron thick film, or both (1) and (2). The ethylene polymer also can have at least one of (A) a tan δ at 0.1 sec⁻¹ in a range from 1.5 to 4.5, and/or (B) a CY-a parameter in a range from 0.15 to 0.35, and/or (C) from 2.5 to 13 long chain branches (LCBs) per 1,000,000 total carbon atoms. Thus, the ethylene polymer can have or can be characterized by (A), or by (B), or by (C), or by (A) and (B), or by (A) and (C), or by (B) and (C), or by (A) and (B) and (C). This illustrative and non-limiting example of an ethylene polymer consistent with the present invention also can have any of the polymer properties listed below and in any combination, unless indicated otherwise.

The melt index (MI) of the ethylene polymer, in some aspects, can be in a range from 0.1 to 0.6 g/10 min, from 0.1 to 0.55 g/10 min, from 0.15 to 0.5 g/10 min, from 0.15 to 0.48 g/10 min, or from 0.2 to 0.4 g/10 min. Additionally or alternatively, the high load melt index (HLMI) of the ethylene polymer, in some aspects, can be in a range from 6 to 18 g/10 min, from 7 to 17 g/10 min, from 8 to 15 g/10 min, or from 8 to 14.5 g/10 min. Therefore, the ratio of HLMI/MI of the ethylene polymer often can be in a range from 28 to 50, from 31 to 47, from 31 to 40, or from 33 to 45, although not limited thereto.

The density of the ethylene-based polymer is greater than or equal to 0.91 g/cm³ and less than or equal to 0.93 g/cm³. Representative ranges for the density of the polymer can include from 0.913 to 0.93 g/cm³, from 0.915 to 0.928 g/cm³, from 0.916 to 0.925 g/cm³, or from 0.917 to 0.923 g/cm³.

Advantageously, and unexpectedly given the addition of peroxide, the ethylene polymer has exceptionally low gel counts. This is quantified by laser gel counting of 50 micron film produced from the ethylene polymer and counting the number of gels with a size in diameter in the 200-800 micron range, as further discussed in the example section that follows. The ethylene polymer disclosed herein can have a gel count of less than or equal to 100 gels per ft², and more often, the gel count can be less than or equal to 75, or less than or equal to 50, or less than or equal to 35, gels per ft².

In an aspect, these ethylene polymers can have a CY-a parameter in a range from 0.15 to 0.35. Other suitable ranges for the CY-a parameter include, but are not limited to, from 0.15 to 0.3, from 0.15 to 0.28, from 0.17 to 0.35, or from 0.2 to 0.35. The CY-a parameter is generally inversely related to long chain branching. Increases in long chain branching relate, for example, to increased melt strength and improved bubble stability in blown film processing. Additionally or alternatively, these ethylene polymers can have a relaxation time (Tau(eta) or τ(η)) in a range from 0.05 to 0.8 sec. Other suitable ranges for the relaxation time include, but are not limited to, from 0.05 to 0.3, from 0.06 to 0.8, or from 0.06 to 0.3 sec. A polymer relaxation time typically refers to the time it takes the polymer chains to return to equilibrium after being disturbed. Non-Newtonian fluids have a characteristic memory time scale which is referred to as the relaxation time. When the applied rate of deformation is reduced to zero, these materials relax over their characteristic relaxation time. Generally, Tau(eta) increases with molecular weight, however, the entanglements of the polymer, the long chain branching, the molecular weight, and the molecular weight distribution all influence the relaxation behavior. The CY-a and relaxation time parameters are determined from viscosity data measured at 190° C. and using the Carreau-Yasuda (CY) empirical model described herein.

While not limited thereto, the ethylene polymer can have a zero-shear viscosity (η₀) in a range from 20 to 800 kPa-s, such as from 25 to 750 kPa-s in one aspect, from 25 to 350 kPa-s in another aspect, and from 30 to 250 kPa-s in yet another aspect. Additionally or alternatively, these ethylene polymers can have a tan δ (tan d or tangent delta) at 0.1 sec⁻¹ in a range from 1.5 to 4.5. Other suitable ranges for the tan δ at 0.1 sec⁻¹ include, but are not limited to, from 1.5 to 4, from 1.5 to 3.5, from 2 to 4.5, or from 2 to 4, and the like. The (low frequency) tan δ at 0.1 sec⁻¹ of greater than 1, as opposed to less than 1, is indicative of a polymer with relatively low elasticity at low shear, which can be beneficial for certain film applications, particularly for higher molecular weight polymers. The zero-shear and tan δ rheological parameters are determined from viscosity data measured at 190° C. and using the Carreau-Yasuda (CY) empirical model described herein.

In an aspect, the ethylene polymers typically have from 2 to 13 long chain branches (LCBs) per 1,000,000 total carbon atoms—using the Janzen-Colby model described herein. In some aspects, these ethylene polymers can contain from 2.5 to 13 LCBs, from 2.5 to 10 LCBs, from 3 to 13 LCBs, from 3 to 10 LCBs, from 3 to 8 LCBs, from 4 to 13 LCBs, or from 4 to 10 LCBs per 1,000,000 total carbon atoms. For instance, polymers with higher amounts of LCBs generally have improved melt strength and improved bubble stability in blown film processing.

In an aspect, the ethylene polymer can have a weight-average molecular weight (Mw) in a range from 100,000 to 200,000 g/mol, from 125,000 to 190,000 g/mol, from 140,000 to 185,000 g/mol, from 150,000 to 180,000 g/mol, or from 160,000 to 180,000 g/mol, and the like. Additionally or alternatively, the ethylene polymer can have a peak molecular weight (Mp) in a range from 50,000 to 150,000 g/mol, from 60,000 to 140,000 g/mol, from 75,000 to 130,000 g/mol, from 80,000 to 120,000 g/mol, from 85,000 to 110,000 g/mol, or from 90,000 to 110,000 g/mol, and the like. Additionally or alternatively, the ethylene polymer can have a number-average molecular weight (Mn) in a range from 15,000 to 60,000, from 25,000 to 50,000, from 30,000 to 45,000, or from 35,000 to 40,000 g/mol, and the like. Additionally or alternatively, the ethylene polymer can have a z-average molecular weight (Mz) in a range from 300,000 to 600,000, from 350,000 to 550,000, from 400,000 to 550,000, or from 425,000 to 550,000 g/mol, and the like.

These ethylene polymers have a relatively narrow molecular weight distribution, which can be quantified by a ratio of Mw/Mn, or a polydispersity index, in a range from 2 to 6. Other suitable ranges for the ratio of Mw/Mn include from 2 to 5, from 3 to 6, from 3 to 5, from 3.5 to 4.8, or from 4 to 4.8, and the like.

Ethylene polymers consistent with certain aspects of the invention can have a unimodal molecular weight distribution (as determined using gel permeation chromatography (GPC) or other related analytical technique). Often, in a unimodal molecular weight distribution, there is only a single peak on a molecular weight distribution curve.

Moreover, the ethylene polymers can be produced with Ziegler-Natta catalyst systems containing titanium (and magnesium). In some aspects, the ethylene polymer can contain an amount (in ppm by weight) of titanium in a range from 0.5 ppm to 15 ppm, although not limited thereto. More often, the ethylene polymer contains from 0.5 ppm to 10 ppm of titanium, from 1 ppm to 15 ppm of titanium, or from 1 ppm to 10 ppm of titanium.

Metallocene and chromium based catalysts systems are not required. Therefore, the ethylene polymer can contain no measurable amount of zirconium and/or hafnium and/or chromium (catalyst residue), i.e., less than 0.1 ppm by weight. In some aspects, the ethylene polymer can contain, independently, less than 0.08 ppm, less than 0.05 ppm, or less than 0.03 ppm, of zirconium or hafnium or chromium.

However, in another aspect, the ethylene polymer can be produced with a post-metallocene or a non-metallocene catalyst system. The term “post-metallocene” or “non-metallocene” (also referred to as “post-metallocene or non-metallocene catalyst” or “post-metallocene or non-metallocene compound”) describes transition metal complexes that contain a transition metal, at least one anionic donor ligand, and at least one leaving group with a non-carbon atom directly linking to the metal (such as halogen leaving group(s)), but do not contain any π-coordinated cyclopentadienyl anion donors (e.g., π-bound cyclopentadienyl moiety or substituted cyclopentadienyl moiety), where the complexes are useful for the polymerization of olefins, typically when combined with activator(s).

Additionally or alternatively, the ethylene polymer can contain an amount (in ppm by weight) of calcium in a range from 3 ppm to 50 ppm, although not limited thereto. More often, the ethylene polymer can contain from 3 to 35 ppm, from 3 to 20 ppm, from 10 to 50 ppm, from 10 to 45 ppm, from 10 to 40 ppm, or from 10 to 35 ppm of calcium. It was surprisingly found that the use of a peroxide masterbatch in an inorganic calcium carbonate carrier, using the methods disclosed herein, produced ethylene polymers and films with beneficially low gel levels.

Unexpectedly, particularly given the use of peroxide (and melt processing and optional other additives) to form the ethylene polymer, the ethylene polymer has (e.g., the polymer pellets have) very little off-color and excellent whiteness. The Yellowness Index (YI) of the ethylene polymer can range from 0.03 to 5, and more often, from 0.03 to 3, from 0.05 to 3, from 0.05 to 2.5, from 0.08 to 3, or from 0.08 to 2.5. For YI, a lower number is more white/clear, while a higher number indicates more yellowing (off-color). Additionally or alternatively, the color of the ethylene polymer/pellets can be quantified using the PE color number, where a higher number is more white/clear, while a lower number indicates more yellowing (off-color). The PE color number of the ethylene polymer can range from 100 to 170 in one aspect, from 100 to 160 in another aspect, from 100 to 150 in another aspect, from 120 to 170 in another aspect, from 120 to 160 in yet another aspect, and from 120 to 150 in still another aspect.

The ethylene polymer can further comprise an additive. An additive can be added in the disclosed methods in order to provide beneficial polymer processing or end-use product attributes. Such processes and materials are described in Modern Plastics Encyclopedia, Mid-November 1995 Issue, Vol. 72, No. 12; and Film Extrusion Manual—Process, Materials, Properties, TAPPI Press, 1992. Nonlimiting examples of suitable additives include a phenolic antioxidant, a phosphite antioxidant (e.g., diphosphite), an acid scavenger (e.g., zinc stearate, zinc oxide, and/or calcium stearate), an antiblock additive, a slip additive, a colorant, a filler, a UV additive, an anti-stat additive, or a processing aid, and the like. Typically, combinations of two or more additives are utilized and can be utilized in any combination in or to produce the ethylene polymer.

### Articles and Film Products

Articles of manufacture can be formed from, and/or can comprise, the ethylene polymers of this invention and, accordingly, are encompassed herein. For example, articles which can comprise the polymers of this invention can include, but are not limited to, an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier, and the like. Various processes can be employed to form these articles. Non-limiting examples of these processes include injection molding, blow molding, rotational molding, film extrusion (blown film extrusion, cast film extrusion), sheet extrusion, profile extrusion, thermoforming, and the like.

The resultant article comprising the ethylene polymer, such as a blown film, can further comprise an additive. Suitable additives include, but are not limited to, a phenolic antioxidant, a phosphite antioxidant (e.g., diphosphite), an acid scavenger (e.g., zinc stearate, zinc oxide, and/or calcium stearate), an antiblock additive, a slip additive, a colorant, a filler, a UV additive, an anti-stat additive, or a processing aid, and the like. Combinations of two or more additives can be utilized in any combination and in any suitable amount in the ethylene polymer and the resultant article comprising the ethylene polymer. For instance, the ethylene polymer can contain an acid scavenger, and the acid scavenger can comprise zinc oxide, zinc stearate, calcium stearate, or a combination thereof; alternatively, zinc oxide and calcium stearate; alternatively, zinc stearate and calcium stearate; alternatively, zinc oxide; alternatively, zinc stearate; or alternatively, calcium stearate.

In some aspects of this invention, an article of manufacture can comprise any of the ethylene polymers described herein, and the article of manufacture can be or can comprise a film, i.e., the article can be or can comprise a (monolayer or multilayer) blown film or cast film. Films disclosed herein, whether cast or blown and whether monolayer or multilayer, can be any thickness that is suitable for the particular end-use application, and often, the average film thickness can be in a range from 0.3 to 20 mils or from 0.3 to 5 mils. For certain film applications, such as blown film applications, typical average film thicknesses can be in a range from 0.3 to 5 mils, from 0.4 to 5 mils, from 0.5 to 4 mils, from 0.5 to 2 mils, or from 0.5 to 1.0 mil, and the like.

The (monolayer or multilayer) blown films disclosed herein have excellent impact resistance. For instance, a blown film consistent with aspects of this invention can have a dart impact strength in a range from 20 to 2500 g/mil, from 30 to 2400 g/mil, from 40 to 2300 g/mil, or from 50 to 2250 g/mil, and the like.

The (monolayer or multilayer) blown films disclosed herein also have excellent tear resistance. The tear resistance of the blown films described herein can be characterized by the MD (or TD) Elmendorf tear strength. Suitable ranges for the MD tear strength can include, but are not limited to, from 50 to 550 g/mil, from 60 to 525 g/mil, from 65 to 500 g/mil, or from 70 to 490 g/mil, and the like. Typical ranges for the TD tear strength can include, but are not limited to, from 350 to 1100 g/mil, from 375 to 1000 g/mil, from 400 to 990 g/mil, or from 420 to 980 g/mil, and the like.

Beneficially, the film products encompassed herein can also be characterized by a surprisingly low number of gels. In an aspect, the number of gels/ft² (of a size in diameter of 200-800 microns) of the film is less than that of an otherwise identical film obtained from an ethylene polymer formed by blending the base polymer (the first portion and the second portion), the peroxide compound, and the additive together in one step, under the same film processing conditions.

### Methods for Reducing Gels

In accordance with aspects of this invention, methods for reducing gel levels are provided herein. In one aspect, a first method for making an ethylene polymer with less gels is provided, and in this aspect, the first method can comprise (I) blending (or pre-mixing) a first portion of a base polymer (or alternatively referred to herein as a base resin) with a peroxide compound to produce a first mixture (or alternatively referred to as a blend), (II) contacting the first mixture with a second portion of the base polymer and an additive to produce a second mixture, and (III) melt processing the second mixture through a die to produce the ethylene polymer. The amount of the peroxide groups is from 2 to 50 ppm based on the weight of the resultant ethylene polymer. The number of gels/ft² (of a size in diameter of 200-800 microns in a 50 micron thick film) of the ethylene polymer is less than that of an otherwise identical ethylene polymer obtained by blending the base polymer (the first portion and the second portion), the peroxide compound, and the additive together in one step, under the same processing conditions. As discussed further in the example section that follows, for this first method, gels were measured on 50 micron (2 mil) thick films (produced from the ethylene polymers) using an automated camera-based gel counting machine made by Optical Control System (OCS), Model FSA-100. The system consisted of a light source and a detector. The film was passed through the system, between the light source and the detector. Three square meters of film area were inspected and the gels with sizes (diameters) in the 200-800 micron range were analyzed. The gel counts represent the total gels, irrespective of the source/cause of the gels, on a number of gels/square foot basis.

In another aspect, a second method for making a film with less gels is provided, and in this aspect, the second method can comprise (i) blending a first portion of a base polymer and a peroxide compound to produce a first mixture, (ii) contacting the first mixture with a second portion of the base polymer and an additive to produce a second mixture, (iii) melt processing the second mixture through a die to produce an ethylene polymer, (iv) melt processing the ethylene polymer through a film die to produce the film. The amount of the peroxide groups is from 2 to 50 ppm based on the weight of the resultant ethylene polymer. The number of gels/ft² (of a size in diameter of 200-800 microns) of the film is less than that of an otherwise identical film obtained from an ethylene polymer formed by blending the base polymer (the first portion and the second portion), the peroxide compound, and the additive together in one step, under the same film processing conditions.

The present invention is not limited to any particular method of blending (or pre-mixing) the first portion of the base polymer and the peroxide compound to produce the first mixture. Various methods of blending and/or mixing can be employed, as would be recognized by those of skill in the art. Ordinarily, however, the blending of the first portion of the base polymer and the peroxide compound is performed in a blender. As a non-limiting example, the blending of the first portion of the base polymer and the peroxide compound can be performed in a batch blender.

In these methods, the first portion of the base polymer can be in any suitable form, such as flake, fluff, or powder, and the like. The amount of the first portion of the base polymer is not particularly limited and can be present in any suitable amount. Generally, however, the vast majority of the first mixture is the first portion of the base polymer, and therefore typical amounts of the first portion of the base polymer, based on the weight of the first mixture, can be in a range from 85 to 99 wt. %, from 90 to 99 wt. %, or from 95 to 99 wt.

In these methods, the first portion of the base polymer and the peroxide compound can be blended at any suitable blending temperature, such as, for example, a temperature in a range from 20 to 80° C., a temperature in a range from 30 to 75° C., a temperature in a range from 40 to 70° C., a temperature in a range from 50° C. to 65° C., and so forth, to produce the first mixture. These temperature ranges also are meant to encompass circumstances where steps (I) and (i) are performed at a series of different temperatures, instead of at a single fixed temperature, falling within the respective temperature ranges, wherein at least one temperature is within the recited ranges.

Similarly, the time period for blending the first portion of the base polymer and the peroxide compound to produce the first mixture is not particularly limited, and can be conducted for any suitable period of time. In some aspects, the time period for blending the first portion of the base polymer and the peroxide compound can be from 1 minute to 6 hours, from 30 minutes to 3 hours, from 45 minutes to 2 hours, or from 45 minutes to 1 hour.

The peroxide compound in the first and second method can be any compound containing one or more peroxide (O—O) groups, suitable examples of which can include, but are not limited to, 2,5-dimethyl-2,5-di(t-butylperoxy)hexane, dicumyl peroxide, t-butyl cumyl peroxide, n-butyl-4,4′-di(t-butylperoxy)valerate, 2,5-dimethyl-2,5-di(tert-butylperoxy) hexyne-3, and the like. Combinations of two or more of the peroxide compounds can be utilized, if desired. An example of a compound with three peroxide groups is 2,5-dimethyl-2,5-di(tert-butylperoxy) hexyne-3.

The amount of the peroxide compound in steps (I) and (i) is important to produce an ethylene polymer and film with a low level of gels. Generally, as the amount of the peroxide compound in step (I) and step (i) increases, the number of gels in the resulting ethylene polymer and film increases. Typically, the amount of the peroxide compound in these methods can range from 0.1 to 5 wt. %, from 0.1 to 4 wt. %, from 0.1 to 3 wt. %, from 0.1 to 2 wt. %, or from 0.1 to 1 wt. %, based on the weight of the first mixture. However, the amount (by weight) of the peroxide compound used in the first and second methods is typically of lesser interest, because the amount of peroxide groups is more important, and the molecular weight and the number of peroxide groups per peroxide compound are not consistent amongst all suitable peroxide compounds. Thus, generally, the amount of peroxide groups, based on the weight of the ethylene polymer can be in a range from 2 to 50 ppm, and more often, the amount of the peroxide compound is from 2 to 40 ppm, from 3 to 30 ppm, from 3 to 25 ppm, from 3 to 20 ppm, or from 4 to 14 ppm of the peroxide groups based on the weight of the ethylene polymer.

In these methods, the peroxide compound can be added in neat form in step (I) and step (i). Additionally or alternatively, the peroxide compound can be added in liquid or solid form in step (I) and step (i). For instance, the peroxide compound can be added as a solid prill, dissolved in a mineral oil, or in a liquid form. In one aspect, the peroxide compound can be present in a masterbatch (polymer or non-polymer) at any suitable loading, with representative loadings in a range from 1 to 75 wt. %, from 5 to 60 wt. %, from 5 to 50 wt. %, or from 10 to 40 wt. %, based on a total weight of the masterbatch. As a non-limiting example, the peroxide compound can be present in a masterbatch containing a non-polymer calcium carbonate (CaCO₃) carrier and 25-55 wt. % of 2,5-dimethyl-2,5-di(t-butylperoxy)hexane. When a peroxide masterbatch is utilized in step (I) and step (i), the amount of the peroxide masterbatch is important to produce an ethylene polymer and film with a low level of gels. Generally, as the amount of the peroxide masterbatch in step (I) and step (i) increases, the number of gels in the resulting ethylene polymer and film increases.

The present invention is not limited to any particular method of contacting (or combining) the first mixture with the second portion of the base polymer and the additive to produce the second mixture. Various methods of mixing and/or compounding can be employed, as would be recognized by those of skill in the art. For example, and not limited thereto, a continuous feed blender or feed conveyor can be used. The first mixture, the second portion of the base polymer, and the additive can be contacted in any order or sequence. For instance, the first mixture can be contacted with the second portion of the base polymer first, and then the mixture (or blend) of the first mixture and the second portion of the base polymer can be contacted with the additive. Alternatively, the first mixture can be contacted with the additive first, and then the mixture (or blend) of the first mixture and the additive can be contacted with the second portion of the base polymer. Alternatively, the second portion of the base polymer and the additive can be contacted first, and then the mixture (or blend) of the second portion of the base polymer and the additive can be contacted with the first mixture. Alternatively, the first mixture, the second portion of the base polymer, and the additive can be contacted together in one step (e.g., substantially contemporaneously).

In the first and second methods, the second portion of the base polymer can be in any suitable form, such as flake, fluff, or powder, and the like. Typically, the second portion of the base polymer is in the form of bulk flake. The amount of the second portion of the base polymer in the first and second methods is not particularly limited. Generally, however, the vast majority of the second mixture is the second portion of the base polymer, and therefore typical amounts of the second portion of the base polymer can be at least 90 wt. %, at least 95 wt. %, at least 97 wt. %, at least 98 wt. %, or at least 99 wt. %, based on the weight of the second mixture.

While not limited thereto, the amount of the base polymer in the second portion is generally greater than the amount of the base polymer in the first portion in the methods disclosed herein. Generally, the amount of the second portion of the base polymer, based on the total weight of the first portion and the second portion of the base polymer, can be at least 90 wt. %, at least 95 wt. %, at least 97 wt. %, at least 98 wt. %, or at least 99 wt. %.

In first and second methods, the first mixture, the second portion of the base polymer, and the additive can be blended at any suitable blending temperature, such as, for example, a temperature in a range from 20° C. to 80° C., from 30° C. to 75° C., from 40° C. to 70° C., from 50° C. to 65° C., and so forth, to produce the second mixture. These temperature ranges also are meant to encompass circumstances where steps (II) and (ii) are performed at a series of different temperatures, instead of at a single fixed temperature, falling within the respective temperature ranges, wherein at least one temperature is within the recited ranges. Similarly, the time period for blending the first mixture, the second portion of the base polymer, and the additive to produce the second mixture is not particularly limited, and can be conducted for any suitable period of time. In some aspects, the time period for step (II) and step (ii) can be from 1 minute to 6 hours, from 30 minutes to 3 hours, from 45 minutes to 2 hours, or from 45 minutes to 1 hour.

Referring now to the additive in the first and second methods, the additive can be any suitable additive and can be present in any suitable amount. Non-limiting examples of suitable additives that can be present in steps (II) and (ii) include a phenolic antioxidant, a phosphite antioxidant (e.g., diphosphite), an acid scavenger (e.g., zinc stearate, zinc oxide, and/or calcium stearate), an antiblock additive, a slip additive, a colorant, a filler, a UV additive, an anti-stat additive, or a processing aid, and the like. Any combination of two or more of these additives can be present in steps (II) and (ii), and often are present as an additive system. For instance, the additive can be present as an additive system containing a phenolic antioxidant, a phosphite, antioxidant, and an acid scavenger. The additive (or additive system) can be added in neat form in steps (II) and (ii).

The present invention is not limited to any particular method of melt processing the second mixture in steps (III) and (iii). Ordinarily, however, the melt processing of the second mixture to produce the ethylene polymer utilizes extrusion. For example, the melt processing of the second mixture can be performed in a twin-screw extrusion system, a single-screw extrusion system, or a continuous mixer. While not limited thereto, suitable twin-screw extrusion systems include an intermeshing counter-rotating twin screw extrusion system (parallel and/or conical), a tangential counter-rotating twin screw extrusion system (parallel and/or conical), or a co-rotating twin screw extrusion system (parallel and/or conical)), and the like. The twin screw extrusion system can include any combination of feeding, melting, mixing, and conveying elements. For instance, the twin screw extrusion system can contain all or a majority of mixing elements.

The second mixture can be melt processed at any suitable melt processing temperature, such as, for example, a temperature in a range from 100 to 400° C., a temperature in a range from 150 to 300° C., a temperature in a range from 175 to 275° C., and so forth. These temperature ranges also are meant to encompass circumstances where steps (III) and (iii) are performed at a series of different temperatures, instead of at a single fixed temperature, falling within the respective temperature ranges, wherein at least one temperature is within the recited ranges. The appropriate temperature may depend upon the composition of the peroxide compound and the temperature at which it liberates peroxide groups, but generally is a temperature sufficient to generate peroxide groups at from 2 to 50 ppm of peroxide groups based on the weight of the ethylene polymer.

While not limited thereto, melt processing of the second mixture can be through a pelletizing die or a strand die to produce the ethylene polymer. The ethylene polymer can be in any suitable form, such as pellets or beads and the like. Advantageously, and unexpectedly given the addition of peroxide, the ethylene polymer can have a gel count of less than or equal to 100 gels per ft², and in some aspects, less than or equal to 75, or less than or equal to 50, or less than or equal to 35, gels per ft², wherein the gels have a size in diameter of 200-800 microns in a 50 micron thick film.

The ethylene polymer in steps (III) and (iii) can be characterized by a melt index (MI) in a range from 0.1 to 0.7 g/10 min, a high load melt index (HLMI) in a range from 5 to 20 g/10 min, a density in a range from 0.91 to 0.93 g/cm³, (1) from 3 to 50 ppm by weight of calcium and/or (2) a gel count of less than or equal to 100 gels/ft², wherein the gels have a size in diameter of 200-800 microns in a 50 micron thick film, and at least one of (A) a tan δ at 0.1 sec⁻¹ in a range from 1.5 to 4.5, and/or (B) a CY-a parameter in a range from 0.15 to 0.35, and/or (C) from 2.5 to 13 long chain branches (LCBs) per 1,000,000 total carbon atoms.

Moreover, the ethylene polymer can have a ratio of Mw/Mn from 2 to 6, a Mw from 100,000 to 200,000 g/mol, a Mp from 50,000 to 150,000 g/mol, a Mn from 15,000 to 60,000 g/mol, a Mz from 300,000 to 600,000 g/mol, a zero-shear viscosity from 20 to 800 kPa-s, a relaxation time (Tau(eta) or τ(η)) from 0.05 to 0.8 sec, and/or a ratio of HLMI/MI from 28 to 50.

Referring now to the second method, the ethylene polymer is melt processed in step (iv) through a film die to produce the film. While not limited thereto, the melt processing of the ethylene polymer through the film die to produce the film ordinarily utilizes extrusion. For example, the melt processing of the ethylene polymer to form the film can be performed in a single screw extrusion system. In one aspect of the second method, the film die is a blown film die and the film is a blown film, while in another aspect, the film die is a cast film die and the film is a cast film.

In the second method, the ethylene polymer can be melt processed at any suitable melt processing temperature to form the film, such as, for example, a temperature in a range from 150 to 400° C., a temperature in a range from 150 to 300° C., a temperature in a range from 175 to 275° C., and so forth. These temperature ranges also are meant to encompass circumstances where step (iv) of the second method is performed at a series of different temperatures, instead of at a single fixed temperature, falling within the respective temperature ranges, wherein at least one temperature is within the recited ranges. The appropriate temperature may depend upon the type of film die utilized and the type of film produced (e.g., blown versus cast), as well as the end-use application for the blown film or cast film, amongst other variables.

Referring now to both the first method and the second method, the film (or the blown film) can be any suitable thickness, and often, the average film thickness can be in a range from 0.3 to 20 mils or from 0.3 to 5 mils. For certain film applications, such as blown film applications, typical average film thicknesses can be in a range from 0.3 to 6 mils, from 0.4 to 5 mils, from 0.5 to 4 mils, from 0.5 to 2 mils, or from 0.5 to 1.0 mil, and the like.

Advantageously, the film (or the blown film) produced from the ethylene polymer in the first and second methods has an improved (reduced) level of gels, unexpectedly, due to blending (or pre-mixing) the peroxide compound with the first portion of the base polymer first, without the presence of the additive (or additives). In one aspect, for instance, the film (or the blown film) has a number of gels/ft² (of a size in diameter of 200-800 microns) that is less than that of an otherwise identical film obtained from an ethylene polymer formed by blending the base polymer (the first portion and the second portion), the peroxide compound, and the additive together in one step, under the same film processing conditions. Typical impact and tear resistance properties of the blown film can include, but are not limited to, a dart impact strength from 20 to 2500 g/mil, a MD Elmendorf tear strength from 50 to 550 g/mil, and/or a TD Elmendorf tear strength from 350 to 1100 g/mil.

The base polymer (or base resin) that is used to produce the ethylene polymer in the first method and the second method can be any homopolymer of ethylene or copolymer, terpolymer, etc., of ethylene and at least one olefin comonomer. Thus, the base polymer (and the ethylene polymer) can comprise an ethylene/α-olefin copolymer, while in another aspect, the base polymer (and the ethylene polymer) can comprise an ethylene homopolymer, and in yet another aspect, the base polymer (and the ethylene polymer) can comprise an ethylene/α-olefin copolymer and an ethylene homopolymer. Accordingly, the base polymer (and the ethylene polymer) can comprise an ethylene/1-butene copolymer, an ethylene/1-hexene copolymer, an ethylene/1-octene copolymer, an ethylene homopolymer, or any combination thereof; alternatively, an ethylene/1-butene copolymer, an ethylene/1-hexene copolymer, an ethylene/1-octene copolymer, or any combination thereof; or alternatively, an ethylene/1-hexene copolymer. Typically, for example, if the base polymer (or the base resin) is an ethylene/1-hexene copolymer, then the ethylene polymer produced from the base resin also is an ethylene/1-hexene copolymer, although mixtures and combinations of various types of homopolymers and copolymers can be used.

In order to produce an ethylene polymer having the properties and benefits disclosed herein, a suitable base polymer (or base resin) is used. An illustrative and non-limiting example of a base polymer of the present invention can have a melt index (MI) in a range from 0.1 to 0.7 g/10 min, a high load melt index (HLMI) in a range from 5 to 20 g/10 min, and a density in a range from 0.91 to 0.93 g/cm³, and one or more of the following properties: a gel count of less than or equal to 100 gels/ft², wherein the gels have a size in diameter of 200-800 microns in a 50 micron thick film, a zero-shear viscosity (η₀) in a range from 15 to 40 kPa-s, a relaxation time (Tau(eta) or τ(η)) in a range from 0.04 to 0.075 sec, a CY-a parameter in a range from 0.37 to 0.39, a tan δ at 0.1 sec⁻¹ in a range from 4.7 to 6, and from 0.5 to 2 long chain branches (LCBs) per 1,000,000 total carbon atoms.

The base polymer can be further characterized by a ratio of Mw/Mn of from 2 to 6, and/or a Mw of from 100,000 to 200,000 g/mol, and/or a Mp from 50,000 to 150,000 g/mol, and/or a Mn from 15,000 to 60,000 g/mol, and/or a Mz from 300,000 to 600,000 g/mol, and in some aspects, the base polymer can a ratio of Mw/Mn of from 2 to 6, and a Mw of from 100,000 to 200,000 g/mol, a Mp from 50,000 to 150,000 g/mol, a Mn from 15,000 to 60,000 g/mol, and a Mz from 300,000 to 600,000 g/mol. Additionally, the base polymer can have a unimodal molecular weight distribution.

Generally, the base polymers can be produced with Ziegler-Natta catalyst systems containing titanium (and magnesium). Representative Ziegler-Natta catalyst systems, reactor types, and polymerization reaction conditions that can be used to produce the base polymer resin are disclosed in U.S. Pat. Nos. 3,248,179, 4,501,885, 5,565,175, 5,575,979, 6,239,235, 6,262,191, 6,833,415, 7,226,886, 8,822,608, 9,963,523, 10,799,847, 10,844,147, 11,186,707, 11,453,733, 11,767,378, and 11,845,815, and EP 4019583.

In some aspects, the base polymer (and the ethylene polymer) can contain an amount (in ppm by weight) of titanium in a range from 0.5 ppm to 15 ppm, although not limited thereto. More often, these polymers contain from 0.5 ppm to 10 ppm of titanium, from 1 ppm to 15 ppm of titanium, or from 1 ppm to 10 ppm of titanium.

Metallocene and chromium based catalysts systems are not required. Therefore, the base polymer (and the ethylene polymer) can contain no measurable amount of zirconium and/or hafnium and/or chromium (catalyst residue), i.e., less than 0.1 ppm by weight. In some aspects, the base polymer (and the ethylene polymer) can contain, independently, less than 0.08 ppm, less than 0.05 ppm, or less than 0.03 ppm, of zirconium or hafnium or chromium.

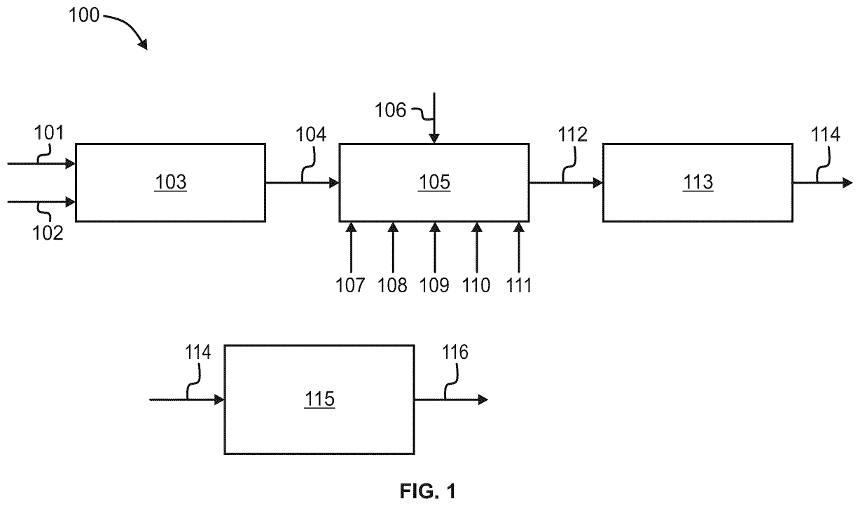

Referring now to FIG. 1, which illustrates a schematic flow diagram of method 100 for making an ethylene polymer and a film with less gels in accordance with aspects of the present disclosure. First portion of base polymer 101 and peroxide compound 102 are blended in batch blender 103 to form first mixture 104. Next, first mixture 104 is contacted in mixer 105 with second portion of base polymer 106 and a plurality of additives that can include phenolic antioxidant 107, phosphite antioxidant 108, acid scavenger 109, antiblock additive 110, and slip additive 111 to form second mixture 112. Note that not all of these additive types are used in all instances. Then, second mixture 112 is melt processed through extruder and die 113 to form ethylene polymer 114. Finally, ethylene polymer 114 is melt processed through extruder and film die 115 to form film 116.

### EXAMPLES

The invention is further illustrated by the following examples, which are not to be construed in any way as imposing limitations to the scope of this invention. Various other aspects, modifications, and equivalents thereof which, after reading the description herein, can suggest themselves to one of ordinary skill in the art without departing from the spirit of the present invention or the scope of the appended claims.

Melt index (MI, g/10 min) was determined in accordance with ASTM D1238 at 190° C. with a 2.16 kg weight (condition F). High load melt index (HLMI, g/10 min) was determined in accordance with ASTM D1238 at 190° C. with a 21.6 kg weight (condition E). Density was determined in grams per cubic centimeter (g/cm³) on a compression molded sample, cooled at 15° C. per minute, and conditioned for 40 hours at room temperature in accordance with ASTM D1505 and ASTM D4703.

Molecular weights and molecular weight distributions were obtained using a PL-220 GPC (Polymer Labs, an Agilent Company) system equipped with a IR4 detector (Polymer Char, Spain) and three Styragel HMW-6E GPC columns (Waters, 12-20 μm pore size, 7.8 mm×300 mm) running at 145° C. The flow rate of the mobile phase 1,2,4-trichlorobenzene (TCB) containing 0.5 g/L 2,6-di-t-butyl-4-methylphenol (BHT) was set at 1 mL/min, and polymer solution concentrations were approximately 1 mg/mL, depending on the molecular weight. Sample preparation was conducted at 150° C. for nominally 4 hr with occasional and gentle agitation, before the solutions were transferred to sample vials for injection. An injection volume of about 400 μL was used. The integral calibration method was used to deduce molecular weights and molecular weight distributions using a Chevron Phillips Chemical Company's HDPE polyethylene resin, MARLEX® BHB5003, as the standard. An integral table of the broad standard was pre-determined in a separate experiment with SEC-MALS. Mn is the number-average molecular weight, Mw is the weight-average molecular weight, Mz is the z-average molecular weight, My is the viscosity-average molecular weight, and Mp is the peak molecular weight (location, in molecular weight, of the highest point of the molecular weight distribution curve).

Melt rheological characterizations were performed as follows. Small-strain (less than 10%) oscillatory shear measurements were performed on an Anton Paar MCR-302 rheometer using parallel-plate geometry. All rheological tests were performed at 190° C. The complex viscosity |η*| versus frequency (co) data were then curve fitted using the modified three parameter Carreau-Yasuda (CY) empirical model to obtain the zero shear viscosity—η₀, characteristic viscous relaxation time—τ_{η}, and the breadth parameter—a (CY-a parameter). The simplified Carreau-Yasuda (CY) empirical model is shown in Equation 3:

$$\vert η * ( ω ) \vert = \frac{{η}_{0}}{{[ 1 + {( {τ}_{η} ω )}^{a} ]}^{( 1 - n ) / a}} , wherein : \qquad Eq . 3$$

$$\vert η * ( ω ) \vert = magnitude of complex shear viscosity ;$$

$${η}_{0} = zero shear viscosity ;$$

$${τ}_{η} = viscous relaxation time ( Tau ( η ) ) ;$$

$$a = “ breadth ” parameter ( CY - a parameter ) ;$$

$$n = fixes the final power law slope , fixed at 2 / 11 ; and$$

$$ω = angular frequency of oscillatory shearing deformation .$$

Details of the significance and interpretation of the CY model and derived parameters can be found in: C. A. Hieber and H. H. Chiang, Rheol. Acta, 28, 321 (1989); C. A. Hieber and H. H. Chiang, Polym. Eng. Sci., 32, 931 (1992); and R. B. Bird, R. C. Armstrong, and O. Hasseger, Dynamics of Polymeric Liquids, Volume 1, Fluid Mechanics, 2nd Edition, John Wiley & Sons (1987); each of which is incorporated herein by reference in its entirety.

For the dynamic frequency sweep measurements, the polymer samples were compression molded at 182° C. for a total of 3 min. The samples were allowed to melt at a relatively low pressure for 1 min and then subjected to a high molding pressure for an additional 2 min. The molded samples were then quenched in a room temperature press, and then 25 mm diameter disks were stamped out of the molded slabs for the measurement in the rotational rheometer. The measurements were performed in parallel plates of 25 mm diameter at 190° C. using a rotational rheometer (MCR-302, Anton Paar). The test chamber of the rheometer was purged with nitrogen to minimize oxidative degradation. After thermal equilibrium, the specimens were squeezed between the plates to a 1.6 mm thickness, and the excess was trimmed. For the dynamic frequency sweep measurement, small strain (1-10%) oscillatory shear in the linear viscoelastic regime was applied at angular frequencies from 0.0316 to 316 sec⁻¹.

The long chain branches (LCBs) per 1,000,000 total carbon atoms of the overall polymer were calculated using the method of Janzen and Colby (J. Mol. Struct., 485/486, 569-584 (1999)), from values of zero shear viscosity, ηₒ (determined from the Carreau-Yasuda model, described hereinabove), and measured values of Mw obtained using GPC discussed above.

The RHEOTENS 71.97 measures the extensional properties of polymer melts by drawing a vertical melt strand at a constant pull-off speed or with a linear or exponentially accelerating velocity. The RHEOTENS 71.97 measures the force needed to elongate the strand, and calculates elongational stress, draw down ratios, rate of elongation and elongational viscosity. The RHEOTENS 71.97 was used in combination with a ¾-inch diameter single-screw extruder equipped with a melt pump using a 900 deflection head (or exit) die. The melt strand was taken-off only vertically. The melt strength was measured at a melt pump speed of 50 rpm.

Dart impact strength (g) was measured in accordance with ASTM D1709 (method A). Film machine direction (MD) and transverse direction (TD) Elmendorf tear strengths (g/mil) were measured on a Testing Machines tear tester (Model 83-11-00) in accordance with ASTM D1922. Tensile properties, such as yield strength, elongation at break, 1% secant modulus, 2% secant modulus, and Young's Modulus were determined in accordance with ASTM D882.

Calcium, phosphorous, and zinc content of the polymer were determined using XRF analysis. Metals content, such as the amount of catalyst residue in the polymer or article, can be determined by ICP analysis on a PerkinElmer Optima 8300 instrument. Polymer samples can be ashed in a Thermolyne furnace with sulfuric acid overnight, followed by acid digestion in a HotBlock with HCl and HNO₃ (3:1 v:v).

### Examples 2-5 and 7-10

### Comparative Examples C1, C6, and Ca-Cc

The LLDPE resin of Comparative Example C1 was a commercially-available ethylene/1-hexene copolymer (Chevron Phillips Chemical Company LP) produced using a Ziegler-Natta catalyst system. Comparative Example C1 contained 800 ppm primary antioxidant, 1000 ppm secondary antioxidant, and 400 ppm zinc oxide (ZnO) acid scavenger additive. The LLDPE polymers of Examples 2-5 were prepared by first blending a first portion of virgin Comparative Example C1 copolymer (no additives) with 40, 60, 80, and 100 ppm by weight (ppmw) of a peroxide compound using a masterbatch containing a calcium carbonate (CaCO₃) carrier and 45 wt. % of 2,5-dimethyl-2,5-di(t-butylperoxy)hexane to form a first mixture. The first mixture was then mixed with a second portion of the virgin Comparative Example C1 copolymer (in the form of bulk flake) and additives, including 800 ppm primary antioxidant, 1000 ppm secondary antioxidant, and 400 ppm zinc oxide (ZnO) acid scavenger, to form a second mixture. Based on the 22 wt. % of the two 0-0 groups in the peroxide compound, the 40 ppmw to 100 ppmw peroxide compound loadings for Examples 2-5 equates to about 8.8 ppmw to 22 ppmw peroxide groups, respectively, based on the weight of the base polymer.

The second mixtures were melt processed using a twin screw extrusion system, and then pelletized to form the ethylene/1-hexene copolymers of Examples 2-5. Melt processing was performed on a laboratory ZSK-40 twin screw extruder equipped with a melt pump. The extruder was a super compounder with an OD/ID ratio of 1.55 and a 40 mm screw diameter and L/D ratio of 28.875. Nitrogen purge was used at the extruder feed port. The temperatures for the barrels, melt pump, and the die were set at 232° C. Conditions of extrusion rate (48.53 kg/hr), screw speed (230 rpm), and 20 mesh filter screen were used, and resulted in a melt temperature of 247° C. and specific energy of 0.163 kW-hr/kg. A 10-hole strand die plate, a waterbath, and a strand pelletizer were used to produce pellet samples. The pellet count was adjusted to 37 per gram.

The LLDPE resin of Comparative Example C6 was a different commercially-available ethylene/1-hexene copolymer (Chevron Phillips Chemical Company LP) produced using a Ziegler-Natta catalyst system. Comparative Example C6 contained 800 ppm primary antioxidant, 1000 ppm secondary antioxidant, and 400 ppm zinc oxide (ZnO) acid scavenger additive. The LLDPE resins of Examples 7-10 were prepared as described for Examples 2-5 except that the first and second portion of the base polymer was the virgin Comparative Example 2 copolymer (no additives) and the melt processing was performed at a melt temperature of 251° C. and a specific energy of 0.173 kW-hr/kg.

Table I summarizes certain properties of the base polymer of Comparative Examples C1 and C6 and the peroxide-treated ethylene polymers of Examples 2-5 and 7-10. Also included in Table I are Comparative Examples CA-CC. Comparative Examples CA-CC were commercially-available Ziegler-Natta-catalyzed ethylene/1-hexene copolymer resins from Chevron-Philips Chemical Company LP. The ethylene polymers of Comparative Examples CA-CC were formed by blending the base polymer, peroxide compound, and additives including 2600 ppm primary antioxidant, 1800 ppm secondary antioxidant, and 300 ppm calcium stearate (CaSt) acid scavenger, together in one step and then melt processing the mixture through a die.

As shown in Table I, the peroxide-treated ethylene polymers of Examples 2-5 and 7-10 exhibited a decrease in melt index (MI) and high load melt index (HLMI) and an increase in the ratio of HLMI/MI, as compared to the base polymers of Comparative Examples C1 and C6, respectively. Generally, the polymers of Examples 2-5 and 7-10 had MI values in the 0.1 to 0.7 g/10 min range, HLMI values in the 5 to 20 g/10 min range, and densities in the 0.91 to 0.93 g/cm³ range. Table I also demonstrates that the peroxide-treated polymers of Examples 2-5 and 7-10, as compared to the base polymers of Comparative Example C1 and C6, had significantly higher ratios of HLMI/MI; the peroxide-treated polymers of Examples 2-5 and 7-10 had ratios of HLMI/MI in the 31 to 50 range. The peroxide-treated ethylene polymers of Examples 2-5 and 7-10 also had lower melt index (MI) and high load melt index (HLMI) as compared to the polymers of Comparative Examples CA-CC, which contained higher levels of both primary and secondary antioxidants. At the same level of peroxide, lower antioxidant levels increase the peroxide crosslinking efficiency (resulting in lower MI and HLMI).

For the base polymers of Comparative Examples C1 and C6 and the peroxide-treated polymers of Examples 2-5 and 7-10, Table II summarizes molecular weight characteristics, while Table III summarizes certain rheological properties at 190° C. Generally, the peroxide-treated polymers of Examples 2-5 and 7-10 had ratios of Mw/Mn in the 2 to 6 range, Mw values in the 100,000 to 200,000 range, Mp values in the 50,000 to 150,000 range, and tan δ at 0.1 sec⁻¹ values in the 1.5 to 4.8 range.

Table IV summarizes certain rheological properties at 190° C. using the Carreau-Yasuda (CY) empirical model and the number of long-chain branches (LCBs) per 1,000,000 total carbon atoms using the Janzen-Colby model for the base polymers of Comparative Examples C1 and C6 and the peroxide-treated polymers of Examples 2-5 and 7-10. Generally, the peroxide-treated polymers of Examples 2-5 and 7-10 had zero-shear viscosity (η₀) values in the 40 to 800 kPa-sec range, relaxation time (Tau (eta) or τ(η)) values in the 0.08 to 0.8 sec range, CY-a parameters in the 0.10 to 0.37 range, and long chain branch content in the range of from 2 to 13 LCBs per 1,000,000 total carbon atoms. As shown in Table IV, as the peroxide amount was increased, the zero-shear viscosity, the relaxation time, and the number of long chain branches increased, while the CY-a parameter decreased.

Table V summarizes the melt strength at a draw down ratio of 2.6 (N) for the base polymers of Comparative Examples C1 and C6 and the peroxide-treated polymers of Examples 2-5 and 7-10. Generally, as the peroxide amount was increased, the melt strength increased.

Blown film samples at a 0.5-mil thickness (13 microns), 1.0-mil thickness (25 microns), 2.0-mil thickness (51 microns), and 4.0-mil thickness (102 microns) were produced from the base polymers of Comparative Examples C1 and C6 and the peroxide-treated ethylene polymers of Examples 2-5 and 7-10. The blown film samples were produced on a LabTech laboratory-scale blown film line using standard in-pocket LLDPE blown film processing conditions as follows: 2-inch diameter spiral die, 1 mm die gap, single lip air ring, 40 mm diameter single-screw extruder with a Maddock mixing section and a Pineapple mixing section at the end of the screw (L/D=30), frost line height (FLH) was 4.25-inch, blow-up ratio (BUR) was 3:1, and 18 lb/hr output rate. The extruder barrel and the die temperatures were set at 193° C. flat. These particular processing conditions were chosen because the blown film properties so obtained are typically representative of those obtained from larger, commercial scale film blowing conditions.

Table VI summarizes the MD and TD Elmendorf tear strengths and dart drop impact strengths for the 0.5 mil, 1.0 mil, 2.0 mil, and 4.0 mil thick blown film samples. Advantageously, the blown films produced from the peroxide-treated ethylene polymers of Examples 2-5 and 7-10 generally had a dart impact strength in the 20 to 2500 g/mil range, a MD Elmendorf tear strength in the 50 to 550 g/mil range, and a TD Elmendorf tear strength in the 350 to 110 g/mil range. Table VII summarizes the tensile properties for 0.5-mil blown film samples, Table VIII summarizes the tensile properties for 1.0-mil blown film samples, Table IX summarizes the tensile properties for 2.0-mil blown film samples, and Table X summarizes the tensile properties for 4.0-mil blown film samples.

Table XI provides a comparison of the amount of gels in the film samples produced from base polymers of Comparative Examples C1 and C6, the peroxide-treated polymers of Examples 2-5 and 7-10, and the polymers of Comparative Examples CA-CC. Gels were measured on 50 micron (2 mil) thick films produced on a cast film line as described in, for example, U.S. Pat. No. 11,325,997. Gel counting utilized an automated camera-based gel counting machine made by Optical Control System (OCS), Model FSA-100. The system consisted of a light source and a detector. The film was passed through the system, between the light source and the detector. Three square meters of film area were inspected and the gels with sizes (diameters) in the 200-800 micron range were analyzed. The gel counts represent the total gels, irrespective of the source/cause of the gels, on a number of gels/square foot basis.

Unexpectedly, the peroxide-treated ethylene polymers of Examples 2-5 and 7-10 had significantly less gels than that of the commercial ethylene polymers of Comparative Examples CA-CC. Surprisingly, the gel levels of the peroxide-treated ethylene polymers of Examples 2-5 and 7-10 were comparable to the gel levels of the base polymers of Comparative Examples C1 and C6 that were not peroxide treated. These results demonstrate that blending (or pre-mixing) the peroxide compound with a first portion of the base polymer first, without the presence of an additive (or additives), can significantly reduce the number of gels in the final ethylene polymer, compared to an ethylene polymer produced by mixing the base polymer, the peroxide compound, and the additive (or additives) together in one step, under the same processing conditions. Further, despite the addition of the peroxide compound, the gel counts of most of the inventive examples were surprisingly less than 20 gels/ft².

### Examples 12-14 and 16-18

### Comparative Examples C11, C15, and CD-CG

The LLDPE resin of Comparative Example C11 was similar to Comparative Example C1 described above, but produced at a different time. The LLDPE polymers of Examples 12-14 were prepared by first blending a first portion of virgin Comparative Example C11 copolymer (no additives) with 20, 40, and 60 ppm by weight (ppmw) of a peroxide compound using a masterbatch containing a calcium carbonate (CaCO₃) carrier and 45 wt. % of 2,5-dimethyl-2,5-di(t-butylperoxy)hexane to form a first mixture. The first mixture was then mixed with a second portion of the virgin Comparative Example C11 copolymer (in the form of bulk flake) and additives, including 800 ppm primary antioxidant, 1000 ppm secondary antioxidant, and 400 ppm zinc oxide (ZnO) acid scavenger, to form a second mixture. Based on the 22 wt. % of the two O—O groups in the peroxide compound, the 20 ppmw to 60 ppmw peroxide compound loadings for Examples 12-14 equates to about 4.4 ppmw to 13.2 ppmw peroxide groups, respectively, based on the weight of the base polymer. The second mixtures were then melt processed using a twin screw extrusion system, and then pelletized to form the ethylene/1-hexene copolymers of Examples 12-14 in the same manner as described above for Examples 2-5.

The LLDPE resin of Comparative Example C15 was similar to Comparative Example C6 described above, but produced at a different time. The LLDPE polymers of Examples 16-18 were prepared as described above for Examples 7-10.

Table XII summarizes certain properties of the base polymer of Comparative Examples C11 and C15 and the peroxide-treated ethylene polymers of Examples 12-14 and 16-18. Also included in Table XII are Comparative Examples CD-CG. Comparative Examples CD-CG were commercially-available Ziegler-Natta-catalyzed ethylene/1-hexene copolymer resins from Chevron-Philips Chemical Company LP. The ethylene polymer of Comparative Example CD was a sample from a large-scale run of ethylene polymer (pellets) produced similarly to that of Comparative Example C11. The ethylene polymers of Comparative Examples CE-CG were formed by blending the base polymer, peroxide compound, and additives including 2600 ppm primary antioxidant, 1800 ppm secondary antioxidant, and 300 ppm calcium stearate (CaSt) acid scavenger, together in one step and then melt processing the mixture through a die.

As shown in Table XII, the peroxide-treated ethylene polymers of Examples 12-14 and 16-18 exhibited a decrease in melt index (MI) and high load melt index (HLMI) and an increase in the ratio of HLMI/MI, as compared to the base polymers of Comparative Examples C11 and C15, respectively. Generally, the polymers of Examples 12-15 and 16-18 had MI values in the 0.1 to 0.7 g/10 min range, HLMI values in the 5 to 20 g/10 min range, and densities in the 0.91 to 0.93 g/cm³ range. Table XII also demonstrates that the peroxide-treated polymers of Examples 12-14 and 16-18, as compared to the base polymers of Comparative Example C11 and C15, had significantly higher ratios of HLMI/MI; the peroxide-treated polymers of Examples 12-14 and 16-18 had ratios of HLMI/MI in the 28 to 50 range.

For the base polymers of Comparative Examples C11 and C15, the peroxide-treated polymers of Examples 12-14 and 16-18, and Comparative Examples CD-CG, Table XIII summarizes molecular weight characteristics, while Table XIV summarizes certain rheological properties at 190° C. Generally, the peroxide-treated polymers of Examples 12-14 and 16-18 had ratios of Mw/Mn in the 2 to 6 range, Mw values in the 100,000 to 200,000 range, Mp values in the 50,000 to 150,000 range, and tan δ at 0.1 sec⁻⁴ values in the 1.5 to 4.5 range.

Table XV summarizes certain rheological properties at 190° C. using the Carreau-Yasuda (CY) empirical model and the number of long-chain branches (LCBs) per 1,000,000 total carbon atoms using the Janzen-Colby model for the polymers of Comparative Examples C11, C15, and CD-CG, and the peroxide-treated polymers of Examples 12-14 and 16-18. Generally, the peroxide-treated polymers of Examples 12-14 and 16-18 had zero-shear viscosity (η₀) values in the 20 to 800 kPa-sec range, relaxation time (Tau (eta) or τ(η)) values in the 0.05 to 0.8 sec range, CY-a parameters in the 0.15 to 0.35 range, and long chain branch content in the range of from 2.5 to 13 LCBs per 1,000,000 total carbon atoms. As shown in Table XV, as the peroxide amount was increased, the zero-shear viscosity, the relaxation time, and the number of long chain branches increased, while the CY-a parameter decreased.

Table XVI summarizes the melt strength at a draw down ratio of 2.6 (N) for the polymers of Comparative Examples C11, C15, and CD-CG, and the peroxide-treated polymers of Examples 12-14 and 16-18. Generally, as the peroxide amount was increased, the melt strength increased.

Table XVII provides a comparison of the amount of gels in the film samples produced from base polymers of Comparative Examples C11 and C15, the peroxide-treated polymers of Examples 12-14 and 16-18, and the polymers of Comparative Examples CD-CG. Gels were measured on 50 micron (2 mil) thick films produced on a cast film line as described in, for example, U.S. Pat. No. 11,325,997. Gel counting utilized an automated camera-based gel counting machine made by Optical Control System (OCS), Model FSA-100. The system consisted of a light source and a detector. The film was passed through the system, between the light source and the detector. Three square meters of film area were inspected and the gels with sizes (diameters) in the 200-800 micron range were analyzed. The gel counts represent the total gels, irrespective of the source/cause of the gels, on a number of gels/square foot basis.

Unexpectedly, the peroxide-treated ethylene polymers of Examples 12-14 and 16-18 had significantly less gels than that of the commercial ethylene polymers of Comparative Examples CE-CG—the average reduction in gels was approximately 97-98%. Surprisingly, the gel levels of the peroxide-treated ethylene polymers of Examples 12-14 and 16-18 were comparable to the gel levels of the base polymers of Comparative Examples C11 and C15 that were not peroxide treated. These results demonstrate that blending (or pre-mixing) the peroxide compound with a first portion of the base polymer first, without the presence of an additive (or additives), can significantly reduce the number of gels in the final ethylene polymer, compared to an ethylene polymer produced by mixing the base polymer, the peroxide compound, and the additive (or additives) together in one step, under the same processing conditions. Further, despite the addition of the peroxide compound, the gel counts for all the inventive examples were surprisingly less than 60 gels/ft².

Table XVIII provides a comparison of the relative whiteness or the amount of yellowing of samples of the base polymers of Comparative Examples C11 and C15, the peroxide-treated polymers of Examples 12-14 and 16-18, and the polymers of Comparative Examples CD and CG. Two metrics were used. For Yellowness Index (YI), a lower number is more white/clear, while a higher number indicates more yellowing (off-color). Hunter Color numbers were determined using a Hunterlabs Labscan XE in accordance with ASTM D6290, and YI was determined in accordance with ASTM E313. For the PE color number, a higher number is more white/clear, while a lower number indicates more yellowing (off-color). The PE color number is described, for example, in U.S. Pat. Nos. 6,613,823 and 12,173,136. The PE color number was calculated from Hunter “a”, “b”, and “L” values by the following formula: PE color number=L(0.0382L−0.056a−0.3374b).

Advantageously, and surprisingly, the peroxide-treated ethylene polymers of Examples 12-14 and 16-18 had significantly better color/whiteness (lower YI and higher PE color number) as compared to the commercial ethylene polymer of Comparative Example CG, and further, the peroxide-treated ethylene polymers of Examples 12-14 and 16-18 also had comparable color to that of the base polymers of Comparative Examples C11, C15, and CG.

TABLE I
Polymer Properties.

| | Peroxide | Ca | P | Zn | MI | HLMI | Density | |
|---|---|---|---|---|---|---|---|---|
| Example | (ppm) | (ppm) | (ppm) | (ppm) | (g/10 min) | (g/10 min) | (g/cm³) | HLMI/MI |
| C1 | 0 | — | 46.8 | 282 | 0.39 | 11.60 | 0.9190 | 30.13 |
| 2 | 40 | 11.5 | 46.8 | 290 | 0.28 | 10.90 | 0.9179 | 38.79 |
| 3 | 60 | 18.7 | 46.8 | 293 | 0.23 | 9.26 | 0.9178 | 40.09 |
| 4 | 80 | 24.6 | 47.3 | 291 | 0.21 | 9.56 | 0.9177 | 46.18 |
| 5 | 100 | 35.0 | 49.5 | 305 | 0.17 | 8.57 | 0.9181 | 49.83 |
| C6 | 0 | — | 50.5 | 272 | 0.48 | 14.10 | 0.9189 | 29.57 |
| 7 | 40 | 11.3 | 49.7 | 302 | 0.34 | 12.39 | 0.9189 | 36.57 |
| 8 | 60 | 16.8 | 54.5 | 278 | 0.31 | 12.12 | 0.9191 | 39.74 |
| 9 | 80 | 23.9 | 48.4 | 290 | 0.31 | 13.63 | 0.9192 | 43.34 |
| 10 | 100 | 29.7 | 50.9 | 279 | 0.28 | 13.14 | 0.9205 | 46.24 |
| CA | 100 | — | — | — | 0.41 | 15.89 | — | 38.80 |
| CB | 100 | — | — | — | 0.40 | 15.65 | — | 39.13 |
| CC | 150 | — | — | — | 0.34 | 14.39 | — | 42.32 |

TABLE II
Molecular Weight Characterization (molecular weights in kg/mol).

| Example | Mn | Mw | Mz | Mp | Mw/Mn | Mz/Mw |
|---|---|---|---|---|---|---|
| C1 | 40.6 | 179 | 537 | 106 | 4.4 | 3.0 |
| 2 | 42.2 | 173 | 459 | 102 | 4.1 | 2.6 |
| 3 | 42.5 | 177 | 502 | 99 | 4.2 | 2.8 |
| 4 | 42.8 | 176 | 474 | 103 | 4.1 | 2.7 |
| 5 | 43.7 | 176 | 488 | 101 | 4.0 | 2.8 |
| C6 | 38.3 | 170 | 508 | 96 | 4.4 | 3.0 |
| 7 | 38.0 | 167 | 459 | 106 | 4.4 | 2.8 |
| 8 | 36.5 | 169 | 496 | 97 | 4.6 | 2.9 |
| 9 | 37.9 | 163 | 462 | 92 | 4.3 | 2.8 |
| 10 | 36.9 | 164 | 429 | 98 | 4.1 | 2.6 |

TABLE III
Rheological Properties at 190° C.

| | G′ at | G′ at | G″ at | G″ at | Tan δ | Tan δ | G* at | G* at | η* at | η* at |
|---|---|---|---|---|---|---|---|---|---|---|
| | 0.1 1/s | 100 1/s | 0.1 1/s | 100 1/s | at 0.1 | at 100 | 0.1 1/s | 100 1/s | 0.1 1/s | 100 1/s |
| Example | (kPa) | (kPa) | (kPa) | (kPa) | sec⁻¹ | sec⁻¹ | (kPa) | (kPa) | (kPa-s) | (kPa-s) |
| C1 | 0.5 | 207.2 | 2.2 | 171.9 | 4.92 | 0.83 | 2.3 | 269.2 | 22.8 | 2.7 |
| 2 | 1.2 | 204.6 | 3.1 | 163.6 | 2.50 | 0.80 | 3.3 | 261.9 | 33.0 | 2.6 |
| 3 | 1.8 | 209.3 | 3.6 | 163.5 | 2.00 | 0.78 | 4.0 | 265.6 | 40.3 | 2.7 |
| 4 | 2.3 | 211.0 | 4.0 | 162.0 | 1.76 | 0.77 | 4.6 | 266.0 | 45.9 | 2.7 |
| 5 | 2.9 | 213.6 | 4.5 | 161.3 | 1.54 | 0.76 | 5.4 | 267.7 | 53.8 | 2.7 |
| C6 | 0.3 | 139.8 | 1.4 | 121.3 | 5.59 | 0.87 | 1.4 | 185.1 | 14.3 | 1.9 |
| 7 | 0.9 | 193.8 | 2.6 | 162.0 | 2.82 | 0.84 | 2.8 | 252.6 | 28.1 | 2.5 |
| 8 | 1.2 | 186.9 | 2.9 | 153.8 | 2.31 | 0.82 | 3.1 | 242.0 | 31.3 | 2.4 |
| 9 | 1.4 | 179.0 | 2.9 | 150.4 | 2.10 | 0.84 | 3.2 | 233.8 | 32.1 | 2.3 |
| 10 | 1.5 | 175.8 | 3.0 | 147.1 | 1.98 | 0.84 | 3.3 | 229.2 | 33.4 | 2.3 |

TABLE IV
Rheological Properties at 190° C. (Carreau-
Yasuda Model) and Number of LCBs per 1,000,000
Total Carbon Atoms (Janzen and Colby Model).

| | | | | LCB per |
|---|---|---|---|---|
| | | | | Million |
| | η₀ | τ(η) | CY-a | Carbon |
| Example | (kPa-sec) | (sec) | parameter | Atoms |
| C1 | 40 | 0.073 | 0.383 | 1.6 |
| 2 | 83.5 | 0.141 | 0.257 | 4.9 |
| 3 | 169.9 | 0.234 | 0.213 | 6.7 |
| 4 | 297.9 | 0.372 | 0.189 | 8.8 |
| 5 | 742.2 | 0.768 | 0.159 | 12.2 |
| C6 | 19.2 | 0.059 | 0.379 | 0.9 |
| 7 | 60.7 | 0.101 | 0.271 | 4.6 |
| 8 | 96.8 | 0.141 | 0.231 | 5.8 |
| 9 | 139.3 | 0.157 | 0.201 | 8.0 |
| 10 | 178.8 | 0.190 | 0.189 | 9.3 |

TABLE V
Melt Strength at Draw Down Ratio
of 2.6 using RHEOTENS 71.97.

| | Melt Strength - Draw |
|---|---|
| Example | Down Ratio of 2.6 (N) |
| C1 | 0.310 |
| 2 | 0.325 |
| 3 | 0.342 |
| 4 | 0.356 |
| 5 | 0.365 |
| C6 | 0.275 |
| 7 | 0.300 |
| 8 | 0.312 |
| 9 | 0.318 |
| 10 | 0.325 |

TABLE VI
MD and TD Tear Strengths and Dart Drop Impact Strength for Blown Film Samples.

| | | | | | | | | | Dart | Dart | Dart | Dart |
|---|---|---|---|---|---|---|---|---|---|---|---|---|
| | Average | Average | Average | Average | Average | Average | Average | Average | Drop | Drop | Drop | Drop |
| | MD - | MD - | MD - | MD - | TD - | TD - | TD - | TD - | Impact - | Impact - | Impact - | Impact - |
| | 0.5 mil | 1.0 mil | 2.0 mil | 4.0 mil | 0.5 mil | 1.0 mil | 2.0 mil | 4.0 mil | 0.5 | 1.0 | 2.0 | 4.0 |
| Example | (g/mil) | (g/mil) | (g/mil) | (g/mil) | (g/mil) | (g/mil) | (g/mil) | (g/mil) | mil (g) | mil (g) | mil (g) | mil (g) |
| C1 | 382 | 431 | 381 | 455 | 723 | 514 | 500 | 539 | 102 | 980 | 1,662 | 1,969 |
| 2 | 259 | 243 | 272 | 377 | 716 | 533 | 495 | 542 | 110 | 880 | 1,956 | 2,104 |
| 3 | 236 | 142 | 228 | 332 | 663 | 527 | 483 | 521 | 113 | 962 | 1,603 | 2,234 |
| 4 | 152 | 89 | 202 | 318 | 669 | 580 | 463 | 513 | 108 | 948 | 1,733 | 2,235 |
| 5 | 105 | 76 | 173 | 266 | 658 | 550 | 445 | 489 | 86 | 880 | 1,324 | 2,238 |
| C6 | 460 | 450 | 394 | 474 | 932 | 543 | 508 | 501 | 212 | 876 | 1,156 | 1,538 |
| 7 | 321 | 267 | 301 | 385 | 791 | 560 | 520 | 517 | 60 | 826 | 1,180 | 1,553 |
| 8 | 289 | 210 | 269 | 343 | 784 | 560 | 528 | 504 | 110 | 780 | 1,056 | 1,700 |
| 9 | 220 | 126 | 210 | 315 | 731 | 541 | 503 | 504 | 98 | 536 | 1,050 | 1,696 |
| 10 | 183 | 129 | 209 | 321 | 702 | 506 | 495 | 500 | 80 | 553 | 822 | 1,391 |

TABLE VII
Tensile Properties for 0.5-mil Thick Blown Film Samples.

| | MD | TD | MD 1% | TD 1% | MD 2% | TD 2% | MD | TD | MD Tensile | TD Tensile |
|---|---|---|---|---|---|---|---|---|---|---|
| | Young's | Young's | Secant | Secant | Secant | Secant | Strain | Strain | Strength at | Strength at |
| | Modulus | Modulus | Modulus | Modulus | Modulus | Modulus | at Break | at Break | Break | Break |
| Example | (psi) | (psi) | (psi) | (psi) | (psi) | (psi) | (%) | (%) | (psi) | (psi) |
| C1 | 36,495 | 60,522 | 30,979 | 46,756 | 27,577 | 36,161 | 201 | 697 | 9,992 | 8,639 |
| 2 | 37,330 | 63,497 | 32,067 | 48,091 | 29,445 | 35,943 | 176 | 684 | 10,521 | 7,659 |
| 3 | 40,129 | 65,930 | 36,515 | 52,860 | 32,256 | 38,245 | 178 | 703 | 10,147 | 9,235 |
| 4 | 38,325 | 63,384 | 33,364 | 47,507 | 30,441 | 35,487 | 200 | 608 | 10,960 | 5,564 |
| 5 | 38,571 | 65,004 | 32,953 | 49,924 | 31,317 | 37,730 | 182 | 591 | 9,927 | 5,718 |
| C6 | 35,258 | 53,404 | 32,166 | 47,076 | 27,690 | 35,817 | 231 | 644 | 7,933 | 6,149 |
| 7 | 38,420 | 62,154 | 35,278 | 52,812 | 29,812 | 38,515 | 218 | 560 | 12,253 | 5,093 |
| 8 | 41,175 | 66,701 | 37,133 | 53,259 | 32,004 | 39,408 | 220 | 700 | 12,293 | 8,191 |
| 9 | 41,749 | 67,610 | 37,037 | 52,998 | 32,292 | 38,699 | 222 | 730 | 12,505 | 6,808 |
| 10 | 40,410 | 67,415 | 34,806 | 52,026 | 31,148 | 38,588 | 236 | 662 | 13,916 | 6,662 |

TABLE VIII
Tensile Properties for 1.0-mil Thick Blown Film Samples.

| | MD | TD | MD 1% | TD 1% | MD 2% | TD 2% | MD | TD | MD Tensile | TD Tensile |
|---|---|---|---|---|---|---|---|---|---|---|
| | Young's | Young's | Secant | Secant | Secant | Secant | Strain | Strain | Strength | Strength |
| | Modulus | Modulus | Modulus | Modulus | Modulus | Modulus | at Break | at Break | at Break | at Break |
| Example | (psi) | (psi) | (psi) | (psi) | (psi) | (psi) | (%) | (%) | (psi) | (psi) |
| C1 | 29,361 | 34,585 | 26,617 | 29,487 | 22,857 | 24,212 | 384 | 667 | 7,835 | 8449 |
| 2 | 31,097 | 38,259 | 28,045 | 32,769 | 24,502 | 26,680 | 366 | 654 | 8,019 | 8060.6 |
| 3 | 33,741 | 39,611 | 31,546 | 37,353 | 26,734 | 29,258 | 379 | 648 | 8,765 | 8,111 |
| 4 | 33,141 | 46,424 | 30,644 | 39,262 | 26,312 | 31,090 | 356 | 654 | 8,317 | 8,017 |
| 5 | 34,882 | 47,515 | 30,720 | 39,912 | 26,906 | 32,088 | 374 | 648 | 8,632 | 7,543 |
| C6 | 30,950 | 36,341 | 29,961 | 34,531 | 24,528 | 27,014 | 418 | 646 | 7,927 | 7,448 |
| 7 | 31,262 | 37,298 | 30,118 | 34,004 | 25,067 | 26,918 | 395 | 660 | 8,647 | 8,611 |
| 8 | 31,824 | 38,135 | 30,009 | 34,724 | 25,263 | 27,316 | 409 | 681 | 8,745 | 9,089 |
| 9 | 33,854 | 42,671 | 31,561 | 37,820 | 26,666 | 29,793 | 396 | 658 | 8,152 | 7,579 |
| 10 | 34,285 | 43,512 | 30,635 | 37,895 | 26,235 | 30,055 | 434 | 656 | 8,523 | 7,604 |

TABLE IX
Tensile Properties for 2.0-mil Thick Blown Film Samples.

| | MD | TD | MD 1% | TD 1% | MD 2% | TD 2% | MD | TD | MD Tensile | TD Tensile |
|---|---|---|---|---|---|---|---|---|---|---|
| | Young's | Young's | Secant | Secant | Secant | Secant | Strain | Strain | Strength | Strength |
| | Modulus | Modulus | Modulus | Modulus | Modulus | Modulus | at Break | at Break | at Break | at Break |
| Example | (psi) | (psi) | (psi) | (psi) | (psi) | (psi) | (%) | (%) | (psi) | (psi) |
| C1 | 29,526 | 32,820 | 26,223 | 27,778 | 22,508 | 23,078 | 557 | 681 | 8,230 | 8,286 |
| 2 | 29,177 | 31,674 | 27,254 | 29,936 | 23,113 | 23,783 | 555 | 672 | 8,358 | 8,270 |
| 3 | 30,844 | 32,936 | 29,200 | 30,627 | 24,129 | 24,389 | 531 | 686 | 7,692 | 8,680 |
| 4 | 30,613 | 34,263 | 27,748 | 29,870 | 23,386 | 24,429 | 565 | 678 | 8,735 | 8,502 |
| 5 | 31,132 | 35,610 | 27,722 | 30,958 | 23,667 | 25,586 | 564 | 660 | 8,430 | 7,904 |
| C6 | 31,161 | 34,449 | 31,740 | 34,393 | 25,559 | 26,651 | 607 | 700 | 8,490 | 7,940 |
| 7 | 30,765 | 33,507 | 30,894 | 31,757 | 24,786 | 25,000 | 574 | 684 | 8,134 | 7,811 |
| 8 | 30,877 | 33,328 | 29,811 | 29,942 | 24,337 | 24,465 | 574 | 701 | 8,268 | 8,390 |
| 9 | 32,253 | 35,016 | 31,152 | 31,667 | 25,444 | 25,398 | 589 | 693 | 8,388 | 8,071 |
| 10 | 33,083 | 37,175 | 31,119 | 33,886 | 25,452 | 27,033 | 588 | 677 | 7,563 | 7,141 |

TABLE X
Tensile Properties for 4.0-mil Thick Blown Film Samples.

| | MD | TD | MD 1% | TD 1% | MD 2% | TD 2% | MD | TD | MD Tensile | TD Tensile |
|---|---|---|---|---|---|---|---|---|---|---|
| | Young's | Young's | Secant | Secant | Secant | Secant | Strain | Strain | Strength | Strength |
| | Modulus | Modulus | Modulus | Modulus | Modulus | Modulus | at Break | at Break | at Break | at Break |
| Example | (psi) | (psi) | (psi) | (psi) | (psi) | (psi) | (%) | (%) | (psi) | (psi) |
| C1 | 29,944 | 32,522 | 27,929 | 29,983 | 23,931 | 25,185 | 693 | 720 | 7,471 | 7,200 |
| 2 | 32,999 | 32,492 | 30,976 | 30,694 | 25,380 | 25,407 | 675 | 736 | 7,415 | 7,747 |
| 3 | 33,056 | 32,943 | 31,222 | 31,398 | 25,666 | 25,920 | 691 | 716 | 7,851 | 7,360 |
| 4 | 32,682 | 32,333 | 30,883 | 30,092 | 25,594 | 25,299 | 659 | 713 | 7,083 | 7,342 |
| 5 | 32,529 | 33,317 | 29,360 | 30,961 | 24,820 | 26,145 | 639 | 688 | 6,741 | 7,031 |
| C6 | 31,279 | 36,676 | 31,693 | 36,735 | 26,043 | 29,222 | 693 | 713 | 6,800 | 6,644 |
| 7 | 33,529 | 34,253 | 32,588 | 32,922 | 26,347 | 26,771 | 687 | 743. | 7,241 | 7,696 |
| 8 | 33,920 | 34,839 | 32,831 | 33,250 | 26,546 | 26,918 | 682 | 726 | 7,045 | 7,341 |
| 9 | 35,642 | 36,104 | 33,531 | 34,093 | 27,384 | 27,781 | 703 | 731 | 7,246 | 7,249 |
| 10 | 35,767 | 36,749 | 33,069 | 33,631 | 27,089 | 27,857 | 691 | 735 | 6,937 | 7,136 |

TABLE XI
Gel Count Comparison for Comparative Examples C1 and C6,
Examples 2-5 and 7-10, and Comparative Examples CA-CC.

| | Number of gels/ft² in the |
|---|---|
| Example | 200-800 μm range |
| C1 | 13.6 |
| 2 | 11.1 |
| 3 | 13.7 |
| 4 | 17.9 |
| 5 | 33.5 |
| C6 | 12.0 |
| 7 | 14.0 |
| 8 | 10.3 |
| 9 | 16.4 |
| 10 | 19.3 |
| CA | 1,463 |
| CB | 1,483 |
| CC | 1,903 |

TABLE XII
Polymer Properties.

| | Peroxide | Ca | P | Zn | MI | HLMI | Density | |
|---|---|---|---|---|---|---|---|---|
| Example | (ppm) | (ppm) | (ppm) | (ppm) | (g/10 min) | (g/10 min) | (g/cm³) | HLMI/MI |
| C11 | 0 | — | 48.2 | 287 | 0.42 | 12.7 | 0.9179 | 30.02 |
| 12 | 20 | 4.2 | 53.2 | 290 | 0.37 | 12.4 | 0.9185 | 33.33 |
| 13 | 40 | 11.1 | 52.6 | 284 | 0.31 | 11.5 | 0.9180 | 36.62 |
| 14 | 60 | 17.6 | 49.5 | 291 | 0.27 | 11.0 | 0.9186 | 40.59 |
| C15 | 0 | — | 46.5 | 285 | 0.52 | 15.4 | 0.9189 | 29.51 |
| 16 | 20 | 4.2 | 48.2 | 278 | 0.48 | 15.2 | 0.9191 | 31.73 |
| 17 | 40 | 10.8 | 46.8 | 285 | 0.39 | 14.3 | 0.9193 | 36.96 |
| 18 | 60 | 16.9 | 48.6 | 273 | 0.36 | 13.6 | 0.9193 | 37.54 |
| CD | 0 | — | 46.1 | 392 | 0.45 | 13.5 | 0.9169 | 29.93 |
| CE | 110 | 58.2 | 82.2 | — | 0.34 | 13.3 | 0.9197 | 38.67 |
| CF | 110 | 55.3 | 86.0 | — | 0.29 | 12.6 | 0.9189 | 43.99 |
| CG | 110 | 59.1 | 87.1 | — | 0.40 | 15.4 | 0.9193 | 38.57 |

TABLE XIII
Molecular Weight Characterization (molecular weights in kg/mol).

| Example | Mn | Mw | Mz | Mp | Mw/Mn | Mz/Mw |
|---|---|---|---|---|---|---|
| C11 | 38.4 | 170 | 480 | 104 | 4.4 | 2.8 |
| 12 | 37.4 | 170 | 505 | 90 | 4.5 | 3.0 |
| 13 | 38.4 | 164 | 440 | 102 | 4.3 | 2.7 |
| 14 | 38.3 | 165 | 449 | 92 | 4.3 | 2.7 |
| C15 | 39.2 | 161 | 450 | 96 | 4.1 | 2.8 |
| 16 | 37.7 | 159 | 438 | 90 | 4.2 | 2.7 |
| 17 | 37.1 | 159 | 442 | 92 | 4.3 | 2.8 |
| 18 | 37.2 | 159 | 447 | 93 | 4.3 | 2.8 |
| CD | 39.3 | 170 | 509 | 90 | 4.3 | 3.0 |
| CE | 39.0 | 162 | 457 | 89 | 4.1 | 2.8 |
| CF | 33.5 | 167 | 483 | 96 | 5.0 | 2.9 |
| CG | 37.7 | 158 | 441 | 90 | 4.2 | 2.8 |

TABLE XIV
Rheological Properties at 190° C.

| | G′ at | G′ at | G″ at | G″ at | Tan δ | Tan δ | G* at | G* at | η* at | η* at |
|---|---|---|---|---|---|---|---|---|---|---|
| | 0.1 1/s | 100 1/s | 0.1 1/s | 100 1/s | at 0.1 | at 100 | 0.1 1/s | 100 1/s | 0.1 1/s | 100 1/s |
| Example | (kPa) | (kPa) | (kPa) | (kPa) | sec⁻¹ | sec⁻¹ | (kPa) | (kPa) | (kPa-s) | (kPa-s) |
| C11 | 0.4 | 192 | 2.1 | 161.6 | 4.7 | 0.84 | 2.1 | 251.3 | 21.4 | 2.5 |
| 12 | 0.7 | 189 | 2.3 | 157.3 | 3.5 | 0.83 | 2.4 | 264.3 | 24.3 | 2.4 |
| 13 | 1.0 | 194 | 2.8 | 158.5 | 2.7 | 0.82 | 2.97 | 250.8 | 29.5 | 2.5 |
| 14 | 1.4 | 188 | 3.0 | 151.1 | 2.2 | 0.80 | 3.3 | 241.0 | 32.9 | 2.4 |
| C15 | 0.3 | 170 | 1.7 | 149.7 | 5.5 | 0.88 | 1.7 | 226.4 | 16.9 | 2.3 |
| 16 | 0.5 | 169 | 1.9 | 147.4 | 4.0 | 0.87 | 1.9 | 224.1 | 19.5 | 2.2 |
| 17 | 0.7 | 172 | 2.2 | 147.4 | 3.0 | 0.86 | 2.3 | 226.5 | 23.3 | 2.3 |
| 18 | 1.02 | 173 | 2.5 | 146.3 | 2.5 | 0.84 | 2.7 | 226.6 | 26.9 | 2.3 |
| CD | 0.4 | 186 | 1.9 | 159.1 | 5.4 | 0.85 | 1.9 | 244.9 | 19.6 | 2.5 |
| CE | 0.8 | 177 | 2.4 | 149.8 | 2.8 | 0.85 | 2.6 | 232.0 | 25.7 | 2.3 |
| CF | 1.2 | 183 | 2.9 | 149.4 | 2.3 | 0.82 | 3.1 | 236.2 | 31.1 | 2.4 |
| CG | 0.8 | 169 | 2.3 | 145.0 | 2.3 | 0.86 | 2.5 | 222.8 | 24.6 | 2.2 |

TABLE XV
Rheological Properties at 190° C. (Carreau-
Yasuda Model) and Number of LCBs per 1,000,000
Total Carbon Atoms (Janzen and Colby Model).

| | | | | LCB per |
|---|---|---|---|---|
| | | | | Million |
| | η₀ | τ(η) | CY-a | Carbon |
| Example | (kPa-sec) | (sec) | parameter | Atoms |
| C11 | 30 | 0.071 | 0.371 | 2.1 |
| 12 | 41 | 0.086 | 0.316 | 3.1 |
| 13 | 68 | 0.117 | 0.264 | 5.4 |
| 14 | 112 | 0.169 | 0.226 | 6.8 |
| C15 | 22 | 0.055 | 0.384 | 2.0 |
| 16 | 30 | 0.065 | 0.330 | 3.1 |
| 17 | 46 | 0.084 | 0.280 | 4.5 |
| 18 | 72 | 0.111 | 0.241 | 6.1 |
| CD | 26 | 0.064 | 0.387 | 1.7 |
| CE | 56 | 0.098 | 0.267 | 4.9 |
| CF | 97 | 0.149 | 0.231 | 6.1 |
| CG | 57 | 0.094 | 0.251 | 5.4 |

TABLE XVI
Melt Strength at Draw Down Ratio
of 2.6 using RHEOTENS 71.97.

| | Melt Strength - Draw |
|---|---|
| Example | Down Ratio of 2.6 (N) |
| C11 | 0.307 |
| 12 | 0.317 |
| 13 | 0.318 |
| 14 | 0.321 |
| C15 | 0.270 |
| 16 | 0.287 |
| 17 | 0.303 |
| 18 | 0.309 |
| CD | 0.305 |
| CE | 0.338 |
| CF | 0.319 |
| CG | 0.288 |

TABLE XVII
Gel Count Comparison.

| | Number of gels/ft² in the |
|---|---|
| Example | 200-800 μm range |
| C11 | 40.3 |
| 12 | 34.3 |
| 13 | 25.2 |
| 14 | 29.4 |
| C15 | 42.7 |
| 16 | 50.8 |
| 17 | 55.8 |
| 18 | 36.8 |
| CD | 12.9 |
| CE | 1,841 |
| CF | 1,771 |
| CG | 1,847 |

TABLE XVIII
Pellet Color Data.

| Example | PE Color Number | Yellowness Index |
|---|---|---|
| C11 | 160.1 | −1.23 |
| 12 | 146.5 | 0.54 |
| 13 | 148.0 | 0.40 |
| 14 | 149.1 | 0.08 |
| C15 | 147.6 | 0.09 |
| 16 | 133.6 | 1.50 |
| 17 | 133.6 | 1.74 |
| 18 | 130.7 | 2.28 |
| CD | 138.1 | 2.52 |
| CG | 49.3 | 13.0 |

The invention is described herein with reference to numerous aspects and specific examples. Many variations will suggest themselves to those skilled in the art in light of the detailed description. All such obvious variations are within the full intended scope of the appended claims. Other aspects of the invention can include, but are not limited to, the following (aspects are described as “comprising” but, alternatively, can “consist essentially of” or “consist of”):

Aspect 1. A method for making an ethylene polymer with less gels, the method comprising (I) blending (pre-mixing) a first portion of a base polymer and a peroxide compound to produce a first mixture, (II) contacting the first mixture with a second portion of the base polymer (e.g., in the form of bulk flake) and an additive (one or more) to produce a second mixture, and (III) melt processing the second mixture through a die to produce the ethylene polymer, wherein an amount of peroxide groups is from 2 to 50 ppm, based on the weight of the ethylene polymer.

Aspect 2. A method for making a film with less gels, the method comprising (i) blending (pre-mixing) a first portion of a base polymer and a peroxide compound to produce a first mixture, (ii) contacting the first mixture with a second portion of the base polymer (e.g., in the form of bulk flake) and an additive (one or more) to produce a second mixture, (iii) melt processing the second mixture through a die to produce an ethylene polymer, and (iv) melt processing the ethylene polymer through a film die to produce the film, wherein an amount of peroxide groups is from 2 to 50 ppm, based on the weight of the ethylene polymer.

Aspect 3. The method defined in aspect 1 or 2, wherein the first portion of the base polymer is in the form of flake, fluff, or powder.

Aspect 4. The method defined in any one of aspects 1-3, wherein the first portion of the base polymer is present in any suitable amount based on the weight of the first mixture, e.g., from 85 to 99 wt. %, from 90 to 99 wt. %, or from 95 to 99 wt. %.

Aspect 5. The method defined in any one of aspects 1-4, wherein step (I) and step (i) are performed at any suitable temperature, e.g., from 20° C. to 80° C., from 30° C. to 75° C., from 40° C. to 70° C., or from 50° C. to 65° C.

Aspect 6. The method defined in any one of aspects 1-5, wherein step (I) and step (i) are performed for any suitable time period, e.g., from 1 minute to 6 hours, from 30 minutes to 3 hours, from 45 minutes to 2 hours, or from 45 minutes to 1 hour.

Aspect 7. The method defined in any one of aspects 1-6, wherein step (I) and step (i) are performed in a blender (e.g., a batch blender).

Aspect 8. The method defined in any one of aspects 1-7, wherein the peroxide compound is present in any suitable amount based on the weight of the first mixture, e.g., 0.1 to 5 wt. %, from 0.1 to 4 wt. %, from 0.1 to 3 wt. %, from 0.1 to 2 wt. %, or from 0.1 to 1 wt.

Aspect 9. The method defined in any one of aspects 1-8, wherein the amount of the peroxide compound is any suitable ppm amount of the peroxide groups based on the weight of the ethylene polymer, e.g., from 2 to 40 ppm, from 3 to 30 ppm, from 3 to 25 ppm, from 3 to 20 ppm, or from 4 to 14 ppm.

Aspect 10. The method defined in any one of aspects 1-9, wherein the peroxide compound comprises any suitable peroxide compound, e.g., 2,5-dimethyl-2,5-di(t-butylperoxy)hexane, dicumyl peroxide, t-butyl cumyl peroxide, n-butyl-4,4′-di(t-butylperoxy)valerate, 2,5-dimethyl-2,5-di(tert-butylperoxy) hexyne-3, or any combination thereof.

Aspect 11. The method defined in any one of aspects 1-10, wherein the peroxide compound is present in neat form in step (I) and step (i).

Aspect 12. The method defined in any one of aspects 1-11, wherein the peroxide is in liquid or solid form in step (I) and step (i).

Aspect 13. The method defined in any one of aspects 1-10, wherein the peroxide compound is present in a (polymer or non-polymer) masterbatch at any suitable loading, e.g., from 1 to 75 wt. %, from 5 to 60 wt. %, from 5 to 50 wt. %, or from 10 to 40 wt. %, based on a total weight of the masterbatch.

Aspect 14. The method defined in any one of aspects 1-13, wherein step (II) and step (ii) are performed at any suitable temperature, e.g., from 20° C. to 80° C., from 30° C. to 75° C., from 40° C. to 70° C., or from 50° C. to 65° C.

Aspect 15. The method defined in any one of aspects 1-14, wherein step (II) and step (ii) are performed for any suitable time period, e.g., from 1 minute to 6 hours, from 30 minutes to 3 hours, from 45 minutes to 2 hours, or from 45 minutes to 1 hour.

Aspect 16. The method defined in any one of aspects 1-15, wherein the second portion of the base polymer is in the form of flake (e.g., bulk flake), fluff, or powder.

Aspect 17. The method defined in any one of aspects 1-16, wherein the second portion of the base polymer is present in any suitable amount, e.g., at least 90 wt. %, at least 95 wt. %, at least 97 wt. %, at least 98 wt. %, or at least 99 wt. %, based on the weight of the second mixture.

Aspect 18. The method defined in any one of aspects 1-17, wherein the additive comprises any additive disclosed herein, e.g., a phenolic antioxidant, a phosphite antioxidant (e.g., diphosphite), an acid scavenger (e.g., zinc stearate, zinc oxide, and/or calcium stearate), an antiblock additive, a slip additive, a colorant, a filler, a UV additive, an anti-stat additive, a processing aid, or any combination thereof.

Aspect 19. The method defined in aspect 18, wherein the additive comprises the phenolic antioxidant, the phosphite antioxidant, and the acid scavenger.

Aspect 20. The method defined in any one of aspects 1-19, wherein the additive is in neat form in step (II) and step (ii).

Aspect 21. The method defined in any one of aspects 1-20, wherein contacting the first mixture, the second portion of the base polymer, and the additive in step (II) and step (ii) is performed in any order.

Aspect 22. The method defined in any one of aspects 1-21, wherein the melt processing of the second mixture is performed at any suitable melt processing temperature, e.g., from 100 to 400° C., from 150 to 300° C., or from 175 to 275° C.

Aspect 23. The method defined in any one of aspects 1-22 wherein the melt processing of the second mixture comprises extrusion.

Aspect 24. The method defined in any one of aspects 1-23, wherein the melt processing of the second mixture is performed in a twin-screw extruder, a continuous mixer, or a single-screw extruder.

Aspect 25. The method defined in any one of aspects 1-24, wherein the die is a pelletizing die or a strand die.

Aspect 26. The method defined in any one of aspects 1-25, wherein the ethylene polymer is in the form of pellets or beads.

Aspect 27. The method defined in any one of aspects 1-26, wherein the ethylene polymer has less than or equal 100, less than or equal to 75, less than or equal to 50, or less than or equal to 35 gels/ft², wherein the gels have a size in diameter of 200-800 microns in a 50 micron thick film.

Aspect 28. The method defined in any one of aspects 1-27, wherein the ethylene polymer is characterized by a melt index (MI) in a range from 0.1 to 0.7 g/10 min, a high load melt index (HLMI) in a range from 5 to 20 g/10 min, a density in a range from 0.91 to 0.93 g/cm³, (1) from 3 to 50 ppm by weight of calcium and/or (2) a gel count of less than or equal to 100 gels/ft², wherein the gels have a size in diameter of 200-800 microns in a 50 micron thick film, and at least one of (A) a tan δ at 0.1 sec⁻¹ in a range from 1.5 to 4.5, and/or (B) a CY-a parameter in a range from 0.15 to 0.35, and/or (C) from 2.5 to 13 long chain branches (LCBs) per 1,000,000 total carbon atoms.

Aspect 29. The method defined in any one of aspects 1-28, wherein the ethylene polymer has a ratio of Mw/Mn from 2 to 6, a Mw from 100,000 to 200,000 g/mol, a Mp from 50,000 to 150,000 g/mol, a Mn from 15,000 to 60,000 g/mol, a Mz from 300,000 to 600,000 g/mol, a zero-shear viscosity from 20 to 800 kPa-s, a relaxation time (Tau(eta) or τ(η)) from 0.05 to 0.8 sec, and/or a ratio of HLMI/MI from 28 to 50.

Aspect 30. The method defined in any one of aspects 1-29, wherein a number of gels/ft² (of a size in diameter of 200-800 microns in a 50 micron thick film) of the ethylene polymer is less than that of an otherwise identical ethylene polymer obtained by blending the base polymer (the first portion and the second portion), the peroxide compound, and the additive together in one step, under the same processing conditions.

Aspect 31. The method defined in any one of aspects 2-30, wherein the film die is a blown film die and the film is a blown film.

Aspect 32. The method defined in aspect 31, wherein the film has a dart impact strength from 20 to 2500 g/mil, a MD Elmendorf tear strength from 50 to 550 g/mil, and/or a TD Elmendorf tear strength from 350 to 1100 g/mil.

Aspect 33. The method defined in any one of aspects 2-30, wherein the film die is a cast film die and the film is a cast film.

Aspect 34. The method defined in any one of aspects 2-33, wherein step (iv) is performed at any suitable melt processing temperature, e.g., from 150 to 400° C., from 150 to 300° C., or from 175 to 275° C.

Aspect 35. The method defined in any one of aspects 2-34, wherein the melt processing of the ethylene polymer comprises extrusion.

Aspect 36. The method defined in any one of aspects 2-35, wherein the melt processing of the ethylene polymer is performed in a single screw extrusion system.

Aspect 37. The method defined in any one of aspects 2-36, wherein a number of gels/ft² (of a size in diameter of 200-800 microns) of the film is less than that of an otherwise identical film obtained from an ethylene polymer formed by blending the base polymer (the first portion and the second portion), the peroxide compound, and the additive together in one step, under the same film processing conditions.

Aspect 38. The method defined in any one of aspects 1-37, wherein the second portion of the base polymer is present in any suitable amount, e.g., at least 90 wt. %, at least 95 wt. %, at least 97 wt. %, at least 98 wt. %, or at least 99 wt. %, based on a total weight of the first portion and the second portion of the base polymer.

Aspect 39. The method defined in any one of aspects 1-38, wherein the base polymer (or the ethylene polymer) is a Ziegler-Natta based polymer (produced using a Ziegler-Natta catalyst).

Aspect 40. The method defined in any one of aspects 1-39, wherein the base polymer (or the ethylene polymer) has a unimodal molecular weight distribution.

Aspect 41. The method defined in any one of aspects 1-40, wherein the base polymer (or the ethylene polymer) comprises an ethylene homopolymer and/or an ethylene/α-olefin copolymer.

Aspect 42. The method defined in any one of aspects 1-41, wherein the base polymer (or the ethylene polymer) comprises an ethylene homopolymer, an ethylene/1-butene copolymer, an ethylene/1-hexene copolymer, and/or an ethylene/1-octene copolymer.

Aspect 43. The method defined in any one of aspects 1-42, wherein the base polymer (or the ethylene polymer) comprises an ethylene/1-hexene copolymer.

Aspect 44. The method defined in any one of aspects 1-43, wherein the base polymer (or the ethylene polymer) contains an amount (in ppm by weight) of zirconium (or hafnium, or chromium, independently), in any suitable range, e.g., less than 0.1 ppm, less than 0.08 ppm, less than 0.05 ppm, or less than 0.03 ppm, of zirconium (or hafnium, or chromium, independently).

Aspect 45. The method defined in any one of aspects 1-44, wherein the base polymer (or the ethylene polymer) contains an amount (in ppm by weight) of titanium in any suitable range, e.g., from 0.5 ppm to 15 ppm, from 0.5 ppm to 10 ppm, from 1 ppm to 15 ppm, or from 1 ppm to 10 ppm, of titanium.

Aspect 46. The method defined in any one of aspects 1-45, wherein the base polymer has a melt index (MI) in a range from 0.1 to 0.7 g/10 min, a high load melt index (HLMI) in a range from 5 to 20 g/10 min, and a density in a range from 0.91 to 0.93 g/cm³, and one or more of the following properties: a gel count of less than or equal to 100 gels/ft², wherein the gels have a size in diameter of 200-800 microns in a 50 micron thick film, a zero-shear viscosity (η₀) in a range from 15 to 40 kPa-s, a relaxation time (Tau(eta) or τ(η)) in a range from 0.04 to 0.075 sec, a CY-a parameter in a range from 0.37 to 0.39, a tan δ at 0.1 sec⁻¹ in a range from 4.7 to 6, and from 0.5 to 2 long chain branches (LCBs) per 1,000,000 total carbon atoms.

Aspect 47. The method defined in aspect 46, wherein the base polymer is further characterized by a ratio of Mw/Mn from 2 to 6, a Mw from 100,000 to 200,000 g/mol, a Mp from 50,000 to 150,000 g/mol, a Mn from 15,000 to 60,000 g/mol, and a Mz from 300,000 to 600,000 g/mol.

Aspect 48. An ethylene polymer having (or characterized by) a melt index (MI) in a range from 0.1 to 0.7 g/10 min, a high load melt index (HLMI) in a range from 5 to 20 g/10 min, a density in a range from 0.91 to 0.93 g/cm³, (1) from 3 to 50 ppm by weight of calcium and/or (2) a gel count of less than or equal to 100 gels/ft², wherein the gels have a size in diameter of 200-800 microns in a 50 micron thick film, and at least one of (A) a tan δ at 0.1 sec⁻¹ in a range from 1.5 to 4.5, and/or (B) a CY-a parameter in a range from 0.15 to 0.35, and/or (C) from 2.5 to 13 long chain branches (LCBs) per 1,000,000 total carbon atoms.

Aspect 49. The polymer defined in aspect 48, wherein the MI is in any suitable range, e.g., from 0.1 to 0.6, from 0.1 to 0.55, from 0.15 to 0.5, from 0.15 to 0.48, or from 0.2 to 0.4 g/10 min.

Aspect 50. The polymer defined in aspect 48 or 49, wherein the HLMI is in any suitable range, e.g., from 6 to 18, from 7 to 17, from 8 to 15, or from 8 to 14.5 g/10 min.

Aspect 51. The polymer defined in any one of aspects 48-50, wherein the density is in any suitable range, e.g., from 0.913 to 0.93, from 0.915 to 0.928, from 0.916 to 0.925, or from 0.917 to 0.923 g/cm³.

Aspect 52. The polymer defined in any one of aspects 48-51, wherein the ethylene polymer has a gel count of less than or equal to 100 gels/ft², less than or equal to 75 gels/ft², less than or equal to 50 gels/ft², or less than or equal to 35 gels/ft², wherein the gels have a size in diameter of 200-800 microns in a 50 micron thick film.

Aspect 53. The polymer defined in any one of aspects 48-52, wherein the ethylene polymer contains an amount of calcium in any suitable range, e.g., from 3 to 50 ppm, from 3 to 35 ppm, from 3 to 20 ppm, from 10 to 50 ppm, from 10 to 45 ppm, from 10 to 40 ppm, or from 10 to 35 ppm (by weight).

Aspect 54. The polymer defined in any one of aspects 48-53, wherein the ethylene polymer has a tan δ (tan d or tangent delta) at 0.1 sec⁻¹ in any suitable range, e.g., from 1.5 to 4.5, from 1.5 to 4, from 1.5 to 3.5, from 2 to 4.5, or from 2 to 4.

Aspect 55. The polymer defined in any one of aspects 48-54, wherein the ethylene polymer has a CY-a parameter in any suitable range, e.g., from 0.15 to 0.35, from 0.15 to 0.3, from 0.15 to 0.28, from 0.17 to 0.35, or from 0.2 to 0.35.

Aspect 56. The polymer defined in any one of aspects 48-55, wherein the ethylene polymer has from 2.5 to 13, from 2.5 to 10, from 3 to 13, from 3 to 10, from 3 to 8, from 4 to 13, or from 4 to 10 LCBs per 1,000,000 total carbon atoms.

Aspect 57. The polymer defined in any one of aspects 48-56, wherein the ethylene polymer has a zero-shear viscosity (η₀) in any suitable range, e.g., from 20 to 800, from 25 to 750, from 25 to 350, or from 30 to 250 kPa-s.

Aspect 58. The polymer defined in any one of aspects 48-57, wherein the ethylene polymer has a relaxation time (Tau(eta) or τ(η)) in any suitable range, e.g., from 0.05 to 0.8, from 0.05 to 0.3, from 0.06 to 0.8, or from 0.06 to 0.3 sec.

Aspect 59. The polymer defined in any one of aspects 48-58, wherein the ethylene polymer has a ratio of HLMI/MI in any suitable range, e.g., from 28 to 50, from 31 to 47, from 31 to 40, or from 33 to 45.

Aspect 60. The polymer defined in any one of aspects 48-59, wherein the ethylene polymer has a ratio of Mw/Mn in any suitable range, e.g., from 2 to 6, from 2 to 5, from 3 to 6, from 3 to 5, from 3.5 to 4.8, or from 4 to 4.8.

Aspect 61. The polymer defined in any one of aspects 48-60, wherein the ethylene polymer has a Mw in any suitable range, e.g., from 100,000 to 200,000, from 125,000 to 190,000, from 140,000 to 185,000, from 150,000 to 180,000, or from 160,000 to 180,000 g/mol.

Aspect 62. The polymer defined in any one of aspects 48-61, wherein the ethylene polymer has a Mp in any suitable range, e.g., from 50,000 to 150,000, from 60,000 to 140,000, from 75,000 to 130,000, from 80,000 to 120,000, from 85,000 to 110,000, or from 90,000 to 110,000 g/mol.

Aspect 63. The polymer defined in any one of aspects 48-62, wherein the ethylene polymer has a Mn in any suitable range, e.g., from 15,000 to 60,000, from 25,000 to 50,000, from 30,000 to 45,000, or from 35,000 to 40,000 g/mol.

Aspect 64. The polymer defined in any one of aspects 48-63, wherein the ethylene polymer has a Mz in any suitable range, e.g., from 300,000 to 600,000, from 350,000 to 550,000, from 400,000 to 550,000, or from 425,000 to 550,000 g/mol.

Aspect 65. The polymer defined in any one of aspects 48-64, wherein the ethylene polymer has a Yellowness Index (YI) in any suitable range, e.g., from 0.03 to 5, from 0.03 to 3, from 0.05 to 3, from 0.05 to 2.5, from 0.08 to 3, or from 0.08 to 2.5.

Aspect 66. The polymer defined in any one of aspects 48-65, wherein the ethylene polymer has a PE color number from 100 to 170, from 100 to 160, from 100 to 150, from 120 to 170, from 120 to 160, or from 120 to 150.

Aspect 67. The polymer defined in any one of aspects 48-66, wherein the ethylene polymer has a unimodal molecular weight distribution.

Aspect 68. The polymer defined in any one of aspects 48-67, wherein the ethylene polymer comprises an ethylene homopolymer and/or an ethylene/α-olefin copolymer.

Aspect 69. The polymer defined in any one of aspects 48-68, wherein the ethylene polymer comprises an ethylene homopolymer, an ethylene/1-butene copolymer, an ethylene/1-hexene copolymer, and/or an ethylene/1-octene copolymer.

Aspect 70. The polymer defined any one of aspects 48-69, wherein the ethylene polymer comprises an ethylene/1-hexene copolymer.

Aspect 71. The polymer defined in any one of aspects 48-70, wherein the ethylene polymer comprises an additive selected from a phenolic antioxidant, a phosphite antioxidant (e.g., diphosphite), an acid scavenger (e.g., zinc stearate, zinc oxide, and/or calcium stearate), an antiblock additive, a slip additive, a colorant, a filler, a UV additive, an anti-stat additive, a processing aid, or any combination thereof.

Aspect 72. The polymer defined in any one of aspects 48-71, wherein the ethylene polymer contains, independently, less than 0.1 ppm (by weight), less than 0.08 ppm, less than 0.05 ppm, or less than 0.03 ppm, of zirconium (or hafnium, or chromium, independently).

Aspect 73. The polymer defined in any one of aspects 48-72, wherein the ethylene polymer contains an amount (in ppm by weight) of titanium in any suitable range, e.g., from 0.5 ppm to 15 ppm, from 0.5 ppm to 10 ppm, from 1 ppm to 15 ppm, or from 1 ppm to 10 ppm, of titanium.

Aspect 74. An article comprising the ethylene polymer defined in any one of aspects 48-73.

Aspect 75. An article comprising the ethylene polymer defined in any one of aspects 48-73, wherein the article is an agricultural film, an automobile part, a bottle, a container for chemicals, a drum, a dunnage bag, a fiber or fabric, a food packaging film or container, a food service article, a fuel tank, a geomembrane, a household container, a liner, a molded product, a medical device or material, an outdoor storage product, outdoor play equipment, a pipe, a sheet or tape, a toy, or a traffic barrier.

Aspect 76. An article comprising the ethylene polymer defined in any one of aspects 48-73, wherein the article is a (monolayer or multilayer) blown film or cast film.

Aspect 77. A (monolayer or multilayer) blown film comprising the ethylene polymer defined in any one of aspects 48-73.

Aspect 78. The film defined in aspect 77, wherein the film has a dart impact strength in any suitable range, e.g., from 20 to 2500, from 30 to 2400, from 40 to 2300, or from 50 to 2250 g/mil.

Aspect 79. The film defined in aspect 77 or 78, wherein the film has a MD Elmendorf tear strength in any suitable range, e.g., from 50 to 550, from 60 to 525, from 65 to 500, or from 70 to 490 g/mil.

Aspect 80. The film defined in any one of aspects 77-79, wherein the film has a TD Elmendorf tear strength in any suitable range, e.g., from 350 to 1100, from 375 to 1000, from 400 to 990, or from 420 to 980 g/mil.

Aspect 81. The film defined in any one of aspects 77-80, wherein the film has an average thickness in any suitable range, e.g., from 0.3 to 20, from 0.3 to 5, from 0.4 to 5, from 0.5 to 4, from 0.5 to 2 mils, or from 0.5 to 1.0 mil.

We claim:

1. An ethylene polymer having:
a melt index (MI) in a range from 0.1 to 0.7 g/10 min;
a high load melt index (HLMI) in a range from 5 to 20 g/10 min;
a density in a range from 0.91 to 0.93 g/cm³;
from 3 to 50 ppm by weight of calcium and/or a gel count of less than or equal to 100 gels/ft², wherein gels have a size in diameter of 200-800 microns in a 50 micron thick film; and
at least one of:
a tan δ at 0.1 sec⁻¹ in a range from 1.5 to 4.5; and/or
a CY-a parameter in a range from 0.15 to 0.35, and/or
from 2.5 to 13 long chain branches (LCBs) per 1,000,000 total carbon atoms.

2. The ethylene polymer of claim 1, wherein:
the MI is from 0.15 to 0.5 g/10 min;
the HLMI is from 7 to 17 g/10 min; and
the density is from 0.916 to 0.925 g/cm³.

3. The ethylene polymer of claim 1, wherein the ethylene polymer has from 3 to 50 ppm by weight of the calcium.

4. The ethylene polymer of claim 1, wherein the ethylene polymer has the gel count of less than or equal to 100 gels/ft².

5. The ethylene polymer of claim 1, wherein the ethylene polymer has the tan δ at 0.1 sec⁻¹ in the range from 1.5 to 4.5.

6. The ethylene polymer of claim 1, wherein the ethylene polymer has the CY-a parameter in the range from 0.15 to 0.35.

7. The ethylene polymer of claim 1, wherein the ethylene polymer has from 2.5 to 13 of the LCBs per 1,000,000 total carbon atoms.

8. The ethylene polymer of claim 1, wherein the ethylene polymer has:
a zero-shear viscosity (η₀) from 20 to 800 kPa-s; and/or
a relaxation time (Tau(eta) or τ(η)) from 0.05 to 0.8 sec.

9. The ethylene polymer of claim 1, wherein the ethylene polymer has:
a ratio of HLMI/MI from 28 to 50;
a ratio of Mw/Mn from 2 to 6;
a Mn from 15,000 to 60,000 g/mol;
a Mw from 100,000 to 200,000 g/mol;
a Mz from 300,000 to 600,000 g/mol;
a Mp from 50,000 to 150,000 g/mol; or
any combination thereof.

10. The ethylene polymer of claim 1, wherein the ethylene polymer has:
a Yellowness Index from 0.03 to 5; and/or
a PE color number from 100 to 170.

11. The ethylene polymer of claim 1, wherein the ethylene polymer comprises an ethylene homopolymer, an ethylene/1-butene copolymer, an ethylene/1-hexene copolymer, and/or an ethylene/1-octene copolymer.

12. The ethylene polymer of claim 1, wherein the ethylene polymer contains an additive selected from a phenolic antioxidant, a phosphite antioxidant, an acid scavenger, an antiblock additive, a slip additive, a colorant, a filler, a UV additive, an anti-stat additive, a processing aid, or any combination thereof.

13. The ethylene polymer of claim 1, wherein the ethylene polymer contains:
less than 0.1 ppm by weight, independently, of zirconium, hafnium, and chromium; and/or
from 0.5 to 15 ppm by weight of titanium.

14. A blown film comprising the ethylene polymer of claim 1.

15. The blown film of claim 14, wherein the blown film has:
a dart impact strength from 20 to 2500 g/mil;
a MD Elmendorf tear strength from 50 to 550 g/mil;
a TD Elmendorf tear strength from 350 to 1100 g/mil;
an average thickness from 0.3 to 20 mils; or
any combination thereof.

16. A method for making an ethylene polymer with less gels, the method comprising:
(I) blending a first portion of a base polymer and a peroxide compound to produce a first mixture;
(II) contacting the first mixture with a second portion of the base polymer and an additive to produce a second mixture; and
(III) melt processing the second mixture through a die to produce the ethylene polymer;
wherein an amount of peroxide groups is from 2 to 50 ppm, based on a weight of the ethylene polymer.

17. The method of claim 16, wherein:
the first portion of the base polymer is in the form of flake, fluff, or powder;
the first portion of the base polymer is from 85 to 99 wt. % of the first mixture;
the peroxide compound is from 0.1 to 5 wt. % of the first mixture;
step (I) is performed at a temperature from 20° C. to 80° C.;
step (I) is performed in a blender; or
any combination thereof.

18. The method of claim 16, wherein:
the second portion of the base polymer is in the form of flake, fluff, or powder;
the second portion of the base polymer is at least 90 wt. % of the second mixture;
the additive is in neat form in step (II);
the additive is selected from a phenolic antioxidant, a phosphite antioxidant, an acid scavenger, an antiblock additive, a slip additive, a colorant, a filler, a UV additive, an anti-stat additive, a processing aid, or any combination thereof;
step (II) is performed at a temperature from 20° C. to 80° C.; or
any combination thereof.

19. The method of claim 16, wherein:
the second portion of the base polymer is at least 90 wt. % of a total weight of the first portion and the second portion of the base polymer;
the base polymer is a Ziegler-Natta based polymer;
the amount of the peroxide groups, based on the weight of the ethylene polymer, is from 2 to 40 ppm;
the melt processing of the second mixture comprises extrusion;
the die is a pelletizing die or a strand die;
the ethylene polymer is in the form of pellets or beads; or
any combination thereof.

20. A method for making a film with less gels, the method comprising:
(i) blending a first portion of a base polymer and a peroxide compound to produce a first mixture;
(ii) contacting the first mixture with a second portion of the base polymer and an additive to produce a second mixture;
(iii) melt processing the second mixture through a die to produce an ethylene polymer; and
(iv) melt processing the ethylene polymer through a film die to produce the film;
wherein an amount of peroxide groups is from 2 to 50 ppm, based on a weight of the ethylene polymer.
